(19) United States
(12) Patent Application Publication
(10) Pub. No.: US 2026/0189520 A1
(43) Pub. Date: Jul. 2, 2026

(54) AGENTIC ARCHITECTURE REQUEST ROUTING USING A PAYLOAD-EMBEDDED TOKEN WITH ROUTING INFORMATION

(71) Applicant: American Express Travel Related Services Company, Inc., New York, NY (US)

(72) Inventors: Adrienne HILL, Cave Creek, AZ (US); Alaric M. EBY, Scottsdale, AZ (US); Anand CHANDRAMOHAN, Phoenix, AZ (US); Dagen WANG, Houston, TX (US); Subrahmanyam V. VISHNUVAJHALA, Phoenix, AZ (US); Andras L. FERENCZI, Scottsdale, AZ (US)

(73) Assignee: American Express Travel Related Services Company, Inc., New York, NY (US)

(21) Appl. No.: 19/007,184

(22) Filed: Dec. 31, 2024

(51) Int. Cl. H04L 51/02; H04L 9/32

(52) U.S. Cl. CPC H04L 51/02; H04L 9/3213; H04L 9/3247

(57) ABSTRACT

System, method, and computer program product embodiments control routing of user data within an agentic ecosystem. User preference data, including routing information indicative of at least one preferred, un-preferred, or prohibited route of data flow within the agentic ecosystem, is received and a token is generated based on the user preference data. The token includes the routing information, and is cryptographically signed. An artificial intelligence (AI) agent of the agentic ecosystem is selected based on the routing information and a request message that includes the token and a payload describing a request for a task to be completed by the AI agent is transmitted to the AI agent. A reply message containing a confirmation that the AI agent successfully completed the task or an error message describing a reason why the AI agent did not successfully complete the task is received from the AI agent.

### BACKGROUND

### Field

This application generally relates to monitoring and control of artificial-intelligence (AI) agentic systems for performing tasks, and in particular to agentic architecture request routing using a payload-embedded token with routing information.

### Related Art

Systems for performing tasks may use a monolithic architecture, in which one software application running on one hardware system performs all aspects of a user-requested task, or may call on one or more services (e.g., one or more microservices) to perform the task. The one or more services may reside on different computer systems (e.g., different servers or within a cloud-based hardware) from a user device from which one or more of them is called and/or from each other. The user device and different computer systems hosting the one or more services can be connected via a network (e.g., the internet) on a hardware level and, on a software level, by one or more application programming interfaces (APIs), each of which can serve as contract of communication between two software components, defining expected inputs and return outputs.

Recent developments in machine-learning architectures, including the development of generative AI, such as large language models (LLMs) and systems that can comprehend and/or generate audio, video, or multi-model content in near real time, have led to the creation of autonomous AI agents that may more completely, more flexibly, and more robustly comprehend queries and problems than was previously possible using monolithic or service-based architectures, for example, by automatically resolving ambiguities in sensible ways and breaking down tasks into subtasks that can be addressed in architectures of multiple AI agents working together.

### BRIEF SUMMARY

Disclosed herein are system, apparatus, device, method and/or computer program product embodiments, and/or combinations and sub-combinations thereof, for agentic architecture request routing using a payload-embedded token with routing information. Computer-implemented methods, systems, and non-transitory computer-readable devices as described herein can provide speed, efficiency, and security advantages to computer systems and networks of computer systems. These advantages can be accomplished, for example, by reducing processor cycles and/or memory usage, by conserving network bandwidth, e.g., by refraining from performing suboptimal or non-useful agentic routing, and/or by eliminating or limiting improper dissemination of sensitive user data. The advantages can be accomplished, for example, by de-preferencing or prohibiting the routing of such data to malicious or compromised agents or agents operated by hostile providers or operating in hostile networks or markets. System, method, and computer program product embodiments as described herein can be employed to address problems associated with agentic task performance by using payload-embedded tokens to trace data through data pipelines associated with agentic relationships, so as to proactively preference, de-preference, or prohibit certain agentic interactions, and/or retroactively analyze agentic interactions, thus reducing costs associated with cyberfraud, data theft, and unwanted private data dissemination. System, method, and computer program product embodiments as described herein thus permit human users to enlist agentic systems to perform tasks with greater confidence and convenience.

In an aspect, an example computer-implemented method of routing within an agentic task architecture includes the following. A computer processor receives user preference data comprising routing information indicative of at least one preferred, un-preferred, or prohibited route of data flow within an agentic ecosystem. The computer processor generates a token based on the user preference data. The token includes the routing information. The token is cryptographically signed. The computer processor selects an AI agent of the agentic ecosystem based on the routing information. The computer processor transmits a request message to the AI agent. The request message includes the token and a payload describing a request for a task to be completed by the AI agent. The computer processor receives, from the AI agent, a reply message containing a confirmation that the AI agent successfully completed the task or an error message describing a reason why the AI agent did not successfully complete the task.

System, device, and non-transitory computer-readable medium aspects are also disclosed. Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### BRIEF DESCRIPTION OF THE DRAWINGS

The accompanying drawings are incorporated herein and form a part of the specification.

FIG. 1 is a block diagram illustrating an example service-based architecture for accomplishing tasks.

FIG. 2 is a block diagram illustrating an example agentic architecture for accomplishing tasks.

FIG. 3 is a flow diagram of an example information flow through an agentic architecture.

FIG. 4 is a block diagram of an example agentic activity monitoring and control system.

FIG. 5 is a sequence diagram illustrating example interactions between agents and a logger as may be performed to complete a transaction payment task in accordance with the functioning of the agentic activity monitoring and control system of FIG. 4.

FIG. 6 is a screenshot of an example user interface of a payment card issuer website or mobile device application, including an intelligent statement and interaction chatbot user interface that can be used as a configuration settings user interface.

FIG. 7 is a flow diagram illustrating an example method of agentic routing monitoring and control using a payload-embedded token with routing information, from the perspective of a calling agent.

FIG. 8 is a flow diagram illustrating an example method of agentic routing monitoring and control using a payload-embedded token with routing information, from the perspective of a called agent.

FIG. 9 is a flow diagram illustrating an example method of agentic routing monitoring and control using a payload-embedded token with routing information, from the perspective of an agentic routing monitoring and control system.

FIG. 10 is a block diagram illustrating an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof for agentic architecture request routing using a payload-embedded token with routing information. An agentic architecture includes a plurality of automated AI agents employed to accomplish a task or sub-tasks of a request. An initial request to perform a task can be made by a human user or an AI system. The task can be to answer a question, to perform a purchase transaction or financial transaction (e.g., making a payment by transferring money or digital property such as cryptocurrency, moving money between accounts, invoicing or billing payments or sending reminders for payments due, purchasing or selling securities or other financial instruments), to perform research or information retrieval, to draft or modify (e.g., edit, copyedit, or revise) a document, to generate or modify video, audio, or multimodal content, to develop and/or test software or a software tool (e.g., perform code generation), to diagnose a medical or computer issue or identify one or more software bugs, to set a reminder, to schedule a meeting or appointment, to acquire and/or playback a media content item, to analyze data, to handle customer support or sales support queries, to automate repetitive processes (e.g., data entry, file conversion, or document routing), to assist in prototyping or design tasks, to perform monitoring or diagnostics of systems, to perform predictive maintenance, to develop or devise strategy or planning, to detect fraud, misinformation, or deepfakes, to perform educative or skill training tasks, to perform supply chain optimization, route planning or resource allocation, to perform threat analysis or surveillance, or to model complicated systems (e.g., global climate, physiological, or pharmacokinetic systems), as but a few examples.

Accordingly, an initial request to an AI agent that may result in the construction of an agentic architecture to carry it out may be, as examples, “buy me a coffee mug I'll like,” “plan and book a dream vacation for myself and my spouse,” “fix the refrigerator,” “schedule my car maintenance,” “put half the money in my savings account to more profitable use,” “sell my car before the next registration renewal,” “check whether all my bills have been paid for this month,” “figure out if there's a better cell phone service plan that I can sign up for at lower cost,” “summarize this” (piece of media), or “play this game for me until” (a certain goal is reached). Agents within an agentic architecture may be granted access to private data that may place any of these various requests in context, e.g., by understanding available assets and/or preferences of the requesting human user.

As one example, an agentic architecture may be granted access to the user's streaming content service watchlist or viewing history to determine that the user enjoys a certain movie series, and may order a coffee mug related to the movie series. As another example, an agentic architecture may search records, such as social media account information, to determine the spouse of a user, to understand the spouse's preferences and the financial resources of the user and spouse, and thus to choose an appropriate vacation destination with an affordable itinerary. As another example, an agentic architecture may have access to, or configure itself to obtain, knowledge of the make, model, year, and condition of the user's vehicle, and may access information to ascertain the market value of the vehicle in order to solicit offers or bids for the vehicle (e.g., from other agentic architectures operating on behalf of other users) and sell the vehicle at a fair price. Agents within an agentic architecture may be granted access to control of resources or assets, including private computing resources (e.g., to control of the user's computer or mobile device) and/or of financial resources (e.g., to control of the user's investment accounts, bank accounts, credit accounts, bill accounts, or other financial assets), in order to perform requested tasks. In some examples, an agentic system may develop a plan for accomplishing a requested task and seek confirmation from the requesting user before executing the plan. In some examples, one or more agents of an agentic architecture may control one or more robots to perform tasks in the physical world.

At least some of the AI agents within the agentic architecture can be configured (e.g., trained) to decompose assigned tasks into subtasks and to strategically or organically assemble respective subsidiary agentic architectures on-the-fly in furtherance of a principal task prompted by the initial request. Various agents within the agentic architecture can carry out individual subtasks, or sub-subtasks, etc., of the principal task. As used herein, “subtask” refers to any task performed in furtherance of the principal task, at any level of task subdivision.

The principal task or any subtask can be perform-once, recurring at defined time intervals or other triggers, or continuous (e.g., the principal task may be repetitive or ongoing such that it is not completable but may nevertheless result in useful subtask completions). An agentic architecture formed in response to an initial request can be a fluid structure, being wholly or partially assembled, disassembled, reassembled, or modified at various times in the carrying out of the principal task. One or more agents within the agentic architecture may interact with the user or other agents within the architecture to clarify information or task parameters, and/or to obtain needed authorizations, during the carrying out of the principal task, and sub-portions of the agentic architecture may be modified or reformed based on such clarification. Because each of a plurality of AI agents within an agentic architecture may develop its own agentic architecture to perform subtasks it deems necessary to completing its assigned task, the agentic architecture may take the form of a network or tree, with potentially hundreds, thousands, or millions of AI agent instances initialized, provisioned, and autonomously operated. An agentic architecture may thereby perform actions on behalf of the requesting human or AI user.

One or more agents within an agentic task architecture may interact with one or more other agents within the agentic architecture, with an original requesting user (e.g., via a chatbot user interface displayed by a user computer system or device, email, text message, telephone, etc.), or with other human agents (e.g., via a chatbot user interface displayed by a human agent computer system or device, email, text message, telephone, etc.), e.g., to obtain clarifying information, to request and be granted necessary authorizations or permissions, to explain the necessity of the authorizations or permissions so as to satisfy user doubts as to the necessity of the authorizations or permissions, to receive instructions and to make confirming assurances pertinent to the safe use of resources, and/or to obtain expert help (either from other AI agents or from humans). As examples, an AI agent may be configured (e.g., trained) to request a needed account password, to search for a query using an internet search engine, to post a request for a problem's solution to a public or private message board or chat room where it may be responded to by humans or other AI agents, or to email or call a human agent to obtain information or provide instructions. AI agents may form contracts with other AI agents or human agents according to which services may be rendered and compensated. For example, a price of performing a principal task may be distributed to agents throughout an agentic architecture, e.g., according to established budgets. Agents may be configured to perform honesty and sanity self-checks or counter-checks to ensure that they themselves and other AI agents that they interact with comply with made assurances, fulfill made promises, and otherwise behave responsibly and ethically. Computer systems that host agents that do not perform securely and according to established standards and contracts may be denied access to resources, denied payment for agent services, denied future agent work, or held accountable by other methods.

In these contexts, monitoring and control of agentic architectures, and ensuring that agentic architectures operate efficiently, fairly, loyally, securely, responsibly, and accountably, can pose technical challenges. The actions of misbehaving or disused agents may need to be paused, terminated or, if possible, unwound (e.g., to place assets or resources back into positions before the actions of agents). Misapprehensions of active agents may need to be corrected in order to place the active agents'goals and operations back into conformance with, and in furtherance of, the principal task or a subtask. So-called “zombie” AI agents that remain active after a parent task has been satisfactorily completed or canceled may need to be tracked and terminated. The authorizations of agents may need to be limited when the agents exceed the intended scope of the permissions granted them, or expanded when the agents have insufficient resources to complete their necessary and proper tasks. The security of the agents may need to be inquired upon or rectified to ensure that agents do not improperly leak sensitive information and are not hijacked for improper purposes by malicious actors. Malicious agents or agents hijacked by malicious actors may need to be detected and avoided. At root of many of these challenges, the existence and activities of autonomous AI agents should be trackable in ways that are secure and certain. Some of these challenges are addressed in the present application, as described below.

### Service-based Task Architectures and Agentic Task Architectures

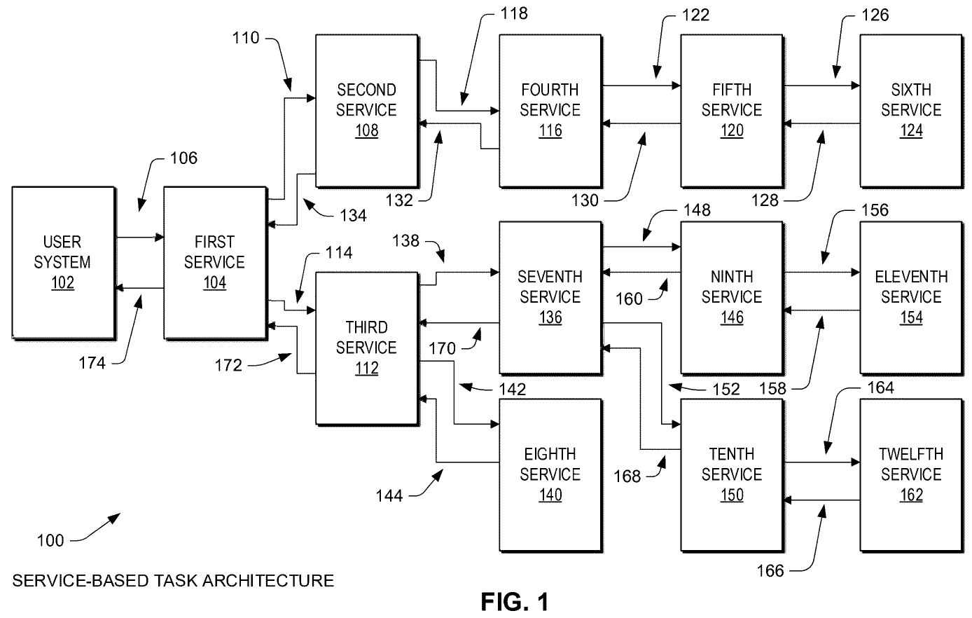

FIG. 1 illustrates an example architecture 100 for carrying out a task by services. The services in architecture 100 are not themselves autonomous AI agents and therefore have more limited capabilities than those that would be had by AI agents, as described in greater detail below. A user system 102 can be configured to accept an initial user request as a user input to the user system 102. In some examples, the user request can be formed by the user as a command in accordance with a defined syntax for the command, whereas in other examples, the user request can be in the form of a natural-language utterance. The user input can be textual (e.g., by physical or virtual keyboard), speech-based (e.g., via a microphone, and/or by inputting an audio file), visual (e.g., via a camera, and/or by inputting a still image or video file), or multimodal, as examples. The request can include data to process or to be used as context information, such as one or more documents, media files, spreadsheets, or databases. The user system 102 can transmit the initial user request, or a data signal derived therefrom, to a first service 104, via link 106. Link 106 can comprise hardware aspects (e.g., physical network connections between the user system 102 and the first service 104), software aspects (e.g., API structure defining the forms of inputs to the first service 104), or both. The first service 104 may be configured to parse and/or process the initial user request and thereby to make one or more determinations about actions to take to satisfy the initial request. For example, the first service 104 may comprehend a limited list of other services that may be employable and appropriate to service the initial request.

The first service 104 may, for example, call on second service 108 via link 110, and third service 112 via link 114. Link 110 may include, for example, an API to second service 108, and, similarly, link 114 may include, for example, an API to third service 112. Second service 108 may be configured to call on one or more other services, such as fourth service 116 via link 118, which may include an API to fourth service 116. Fourth service 116 may, similarly, be configured to place API calls to one or more other services, such as to fifth service 120 via link 122, and fifth service 120 may be configured to place an API call to sixth service 124 via link 126. Sixth service 124 acts as a sub-service to fifth service 120, which in turn acts as a sub-service to fourth service 116, and so on, each called service performing a well-defined subtask and providing well-defined outputs based on well-formed inputs provided over links 126, 122, and 118, respectively.

When the sixth service 124 has completed its processing subtask, the output of the sixth service 124 may be transmitted, in the illustrated example architecture 100, back to the calling fifth service 120 via link 128. Having received the output of the sixth service 124, the fifth service 120 may complete its subtask and provide its output via link 130 back to fourth service 116. Fourth service 116 may make use of the received output of fifth service 120 to complete its subtask and report its own output back to second service 108 via link 132. Second service 108 may subsequently make use of the received output of fourth service 116 to complete its subtask and report its output back to first service 104 via link 134.

Subsequently or meanwhile, first service 104 may have called third service 112. For example, first service 104 may call third service 112 in parallel with the call to second service 108 if the input to third service 112, provided via link 114, does not depend on the output from second service 108 provided via link 134. On the other hand, first service 104 may wait for the output of second service 108 to be provided, via link 134, before calling third service 112 if the input to third service 112 provided via link 114 requires the inclusion of information that is provided by or based on the output of second service 108. Third service 112 may then call seventh service 136 via link 138 and eighth service 140 via link 142. Eighth service 140 may perform its function and return its output to third service 112 via link 144. Seventh service 136 may call ninth service 146 via link 148 and tenth service 150 via link 152. Ninth service 146 may call eleventh service 154 via link 156 and receive the output therefrom via link 158. Ninth service 146 may then complete its function and return its output to seventh service 136 via link 160. Tenth service 150 may call twelfth service 162 via link 164 and receive the output therefrom via link 166. Tenth service 150 may then complete its function and return its output to seventh service 136 via link 168. Ninth service 146 and tenth service 150 may operate contemporaneously in parallel, based on the input of one not depending on the output of the other, or in sequence based on the input of one depending on the output of the other.

Having received responses from both ninth service 146 and tenth service 150, seventh service 136 may complete its function and return its output to third service 112 via link 170. Seventh service 136 and eighth service 140 may operate contemporaneously in parallel, based on the input of one not depending on the output of the other, or in sequence based on the input of one depending on the output of the other. Having received responses from both seventh service 136 and eighth service 140, third service 116 may complete its function and return its output to first service 112 via link 172. Having received responses from both second service 108 and third service 112, first service 104 may complete a response to the user request and return the response to the user system 102 via link 174.

If any of the services in the task architecture 100 is not able to complete its function, it may return an error message, rather than the expected output, via the respective return link. Based on the outputs of each service in the architecture 100 being necessary for formulating the response to the initial user request, an error at any service in the architecture 100 may prevent the expected response to the user request, and instead result, ultimately, in an error message being provided via return link 174. An error may result from malfunctioning of a service (e.g., a software bug in the service or the service being down), or incomplete, inappropriate, malformed, or incorrect inputs being provided to the service, as examples. Because the underlying architecture 100 may be opaque to the user (e.g., from the perspective of user system 102), it may not be clear to the end user or user system 102, solely from the error message ultimately received via link 174, which service or services in the architecture 100 was or were not able to successfully perform its task or their respective tasks. Debugging a user request at runtime may thus be difficult or impossible for the end user after the architecture 100 and its component services are placed into production.

Moreover, the individual services in architecture 100, lacking the cognitive abilities of AI agents, are not capable of interacting with their respective calling services to complete, clarify, or contextualize inputs that may be missing, incorrect, or ambiguous. The individual services thus are not capable of resolving errors, either reactively or proactively, in an automated fashion. Additionally, each service in architecture 100 may be capable only of calling services of which it is made aware programmatically at development time, or from a database that must be manually curated, because the services are not individually capable of searching for or otherwise discovering and procuring for use services that are not expressly provided for at development time. For these reasons, substantial development and testing burden is placed on the developers of the architecture 100 or on individual services within the architecture 100.

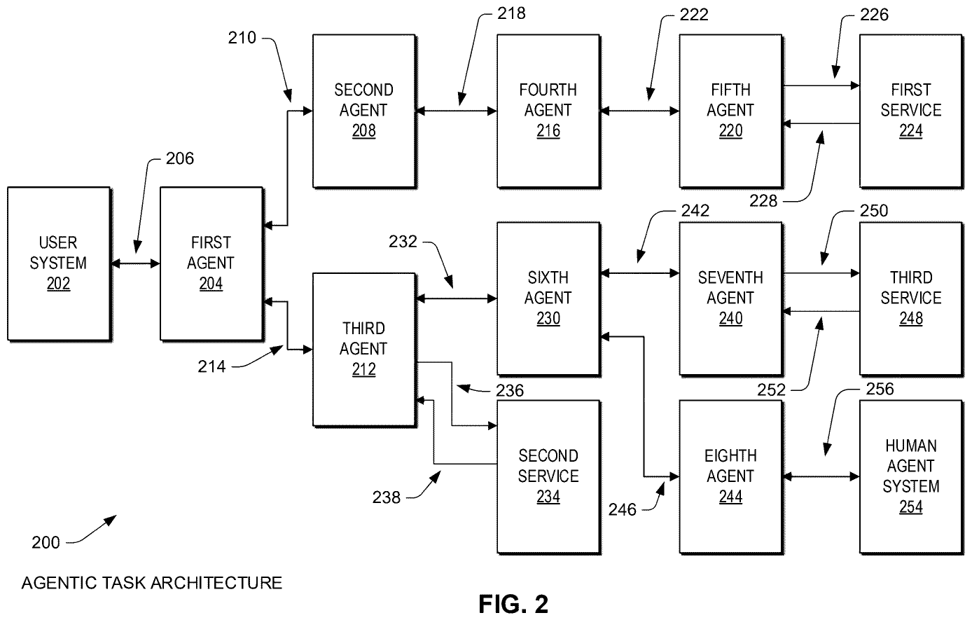

FIG. 2 illustrates an example agentic task architecture 200 comprising a number of agents. Except where stated otherwise, the agents are intelligent autonomous AI systems, having cognitive capabilities that derive from the structures and training of underlying deep-learning models, rather than having their logic hard-coded, as in the case of the services shown in FIG. 1. Although the example agentic task architecture 200 has a graph structure that resembles the graph structure of service-based task architecture 100, agentic task architecture 200 has a number of important differences from, and advantages over, service-based task architecture 100. An agentic task architecture, such as agentic task architecture 200, may be formed from an agentic ecosystem (e.g., an LLM ecosystem) that includes various agents that may be selected from among agents in the agentic ecosystem to form the agentic task architecture. The agentic ecosystem may evolve over time to include new agents and to remove disused, obsoleted, or deprecated agents. Agents in the agentic ecosystem may grow and shed capabilities and access to resources over time. Agents may communicate with each other via a number of methods, modalities, and protocols, including internet-based protocols, such as Hypertext Transfer Protocol (HTTP), and telephony-based protocols. As an example of the latter, AI agents may communicate with each other using speech, in English or another language, over a telephone connection. Agents may use different APIs to call one another or to call different services.

An AI agent may comprise, for example, a machine-learning model (e.g., an LLM) coupled to hard-coded logic to provide cognitive capabilities. Different AI agents may be coupled to each other by communication links, e.g., over the internet, to transmit requests and replies to each other. The cognitive intelligence of an AI agent distinguishes it from the hard-coded procedural functioning of a conventional service, such as the services that make up the service-based task architecture 100 in FIG. 1. An AI agent may use machine-learning capabilities to consider problems and formulate solutions; to decompose larger, more difficult tasks into smaller, easier-to-achieve subtasks; and to independently understand, note, and proactively or reactively resolve ambiguities, errors, or gaps in provided inputs. In some examples, an AI agent may access context-providing data resources, e.g., via the internet, a directory, or a data store to resolve ambiguities, errors, or gaps in provided inputs. In some examples, an AI agent may interactively converse with other AI agents or human agents, such as a calling user, to resolve ambiguities, errors, or gaps in provided inputs. Whereas a service-based task architecture may fail due to accomplish a task due to an input error in the initial user request or due to an error in an intermediate service output developed somewhere along a path in the service-based task architecture, agents in an agentic task architecture may autonomously and/or interactively resolve such an error and accomplish the task, for example, without requiring additional user input to manually resolve the error.

A user system 202 may accept an initial request from a human user as input. The request can take any of the forms described above with regard to the user request in the service-based task architecture 100. The request, or a data signal derived therefrom, can be transmitted to a first agent 204 via connection 206. The first agent 204 can include a deep machine-learning system configured to process the request to determine a task from the request (e.g., “purchase shoes”) and one or more subtasks needed to fulfill the request (e.g., “access a plurality of online shoe stores and compare prices to find the best price among shoes matching the size and style preferences of the user”). As part of this process, the first agent 204 may determine that additional information is needed to complete, contextualize, or disambiguate elements of the request.

The first agent 204 may be configured to interactively converse with the user system 202 (e.g., with the user operating the user system 202, or with information resources or computational resources available to the user system 202) to complete, contextualize, or disambiguate elements of the request. For example, the first agent 204 may determine that the request involves the purchase of new shoes for the user, but the request does not include a shoe size or style preference. First agent 204 may send a textual reply to user system 202 via connection 206 asking for a shoe size and/or style preference. A user reply input to the user system 202 and sent to the first agent 204 via connection 206 will then be considered, cumulatively to the initial user request, in determining one or more subtasks needed to fulfill the request. Additionally or alternatively, first agent 204 may access resources that the first agent 204 is authorized to access, such as one or more purchase histories of the user, to confidently infer missing, incomplete, or ambiguous request-related information, automatedly filling information gaps in the initial user request or in subsequent communications from the user.

The first agent 204 may then carry out the determined subtasks itself, or enlist one or more other agents to fulfill subtasks that the first agent 204 is not competent or not authorized to carry out, or that the other agents may fulfill with some advantage over the first agent 204, e.g., greater efficiency, greater speed, lower cost, less environmental impact, or better accuracy. In the illustrated example, the first agent finds and enlists second agent 208, sending a subtask request to second agent 208 via connection 210, and finds and enlists third agent 212, sending another subtask request (or the same subtask request) to third agent 212 via connection 214.

In some examples, first agent 204 may assign the same subtask request to multiple other agents, effectively engaging the multiple other agents in competition with each other to perform the subtask with the greatest efficiency, the greatest accuracy, the greatest speed, or in accordance with some other metric. For example, the first agent 204 may contract with multiple other agents with the understanding that only the first agent to return a satisfactory completion of the awarded tasks receives compensation for the task.

In some examples, first agent 204 may award subtasks by auction to one or more competing other agents, which may bid against each other for task work. In yet other examples, the first agent 204 may award a subtask to an agent of primary preference but then re-award the task to a different agent of secondary preference after a the agent of primary preference fails to complete the awarded task, or fails to complete it within a certain time. In still other examples, other criteria, such as trust metrics, may dictate how the first agent 204 selects other agents to perform subtasks.

In yet other examples, there may be only one option for choice of agent to perform a subtask, as where only one agent controls or guards some particular resource, such as access to a particular proprietary payment network or data store. As one example, if an agent determines to purchase a particular transit fare (e.g., airfare) as part of a travel booking, the agent may be compelled to use another agent that is owned or controlled by the carrier (e.g., airline) associated with the travel booking. As another example, if an agent determines to use a particular payment card (e.g., credit or debit card) of the user to pay for a good or service, the agent may be compelled to use another agent that is owned or controlled by the payment card issuer to carry out the payment transaction.

In the agentic task architecture 200, the first agent 204 need not be initially aware (e.g., programmatically aware) of the existence of the agents to which it awards subtasks (e.g., agents 208, 212, in the illustrated example). In some examples, the first agent 204 may perform a search for appropriate agents, or make public or private inquiries as to suitable agents matching a given subtask. This may be in contrast to the architecture 100 of FIG. 1, in which each service may need to be programmed, at development time, with the identities of services to call for various subtasks, or to access a database with such identities, which database must then be curated, maintained, and updated. This advantage of the agentic architecture 200 permits for the continual or sporadic emergence of new agents without requiring developer effort to make older agents expressly aware of the new agents.

Second agent 210 may determine that its assigned subtask involves one or more subtasks that may require or advantageously employ another agent to carry out. Accordingly, in the illustrated example, second agent 208 may find and enlist fourth agent 216 and transmit one or more subtask requests to fourth agent 216 via connection 218. Similarly, fourth agent 216 may transmit one or more subtask requests to fifth agent 220 via connection 222. Fifth agent 220 may determine that a conventional service may be accessed to perform a subtask in order to complete the subtask assigned to fifth agent 220 from fourth agent 216, such as a data retrieval or processing task, a transaction task, or a payment task, and accordingly, fifth agent 220 may place an API call to first service 224 via link 226, and receive a response from first service 224 via link 228. Fifth agent 220 may transmit a reply to fourth agent 216 via connection 222, fourth agent 216 may transmit a reply to second agent 208 via connection 218, and second agent 208 may transmit a reply to first agent 204 via connection 210.

First, second, fourth, and fifth agents 204, 208, 216, and 220 may also carry out interactive dialogues with each other via their respective links 210, 218, and 222, e.g., to complete or clarify inputs, reactively or proactively resolve errors, and provide useful feedback data, as described above with regard to the relationship between first agent 204 and user system 202. Requests may be carried up the chain of agentic command, and replies may be transferred back down the chain of agentic command. Accordingly, even if the structure of the agentic task architecture 200 is opaque from the perspective of the user system 202, the architecture 200 is more robust as against failures or errors. As one example, an error generated somewhere within the architecture 200, such as at an endpoint of the architecture graph (e.g., a first service 224), need not propagate all the way back to user system 202 and cause the failure of the initially requested task, if it can be resolved at some intermediate point in the architecture 200. For example, if first service 224 returns an error to fifth agent 220, fifth agent 220 can automatedly revise its API call to first service 224, e.g., after requesting and receiving clarification about input parameters from fourth agent 216, and/or can automatedly determine a substitute service to call, effectively replacing first service 224 in the architecture, e.g., if first service 224 does not perform as expected.

Similar principles may apply in third agent 212 determining sixth agent 230, and transmitting a subtask to sixth agent 230 via connection 232, and in third agent 212 determining second service 234 and transmitting an API call to second service 234 via link 236. Second service 234 may reply to third agent via link 238, and, in the event that the reply is an error, third agent 212 may reformulate and resend its API call to second service 234, or may replace second service 234 in the architecture with another available service. For example, if, per the initial user request, it is imperative that an airfare be booked immediately, but second service 234, belonging to a first airline, cannot book the requested airfare due to a technical failure or lack of available seats meeting the user's travel criteria, third agent 212 may, upon receiving an error message via link 238 (or a timeout), select a different service, e.g., from a competing airline, to replace second service 234 in the architecture 200.

Given that large chains, trees, or networks of agents may be called in the formation of an agentic task architecture, the problem of which agent to select to best accomplish a given task or subtask, from the perspective of any given agent, can be broadly considered as a problem of routing. An agent in an agentic task architecture, such as agentic task architecture 200, may make one or more selections of agents to assign one or more subtasks to, or may make one or more selections of services to interact with, in accordance with reinforcement learning mechanism trained on data from prior agentic architecture task attempts (failures or completions) and the associated routes. Additionally or alternatively, the agent may make selections of other agents and/or services in accordance with rulesets or guidelines that may be supplied to the agents or services in ways that are described in greater detail below.

For example, an agent may access a centralized database or other data store, or a decentralized data store such as a blockchain ledger, to receive rules that are applicable to a particular user being serviced, a particular payment method, a particular market, a particular task objective, or other particular aspects of a task. As one example, a user who has had a bad experience with a particular merchant in the past may determine that the user would not like to do business with the particular merchant in the future, and thus may add the particular merchant to a personal blacklist belonging to the user. In receipt of this blacklist, an agent may determine not to make a purchase from the blacklisted particular merchant or enlist an agent owned or controlled by the blacklisted particular merchant when performing tasks for the user.

As another example, a user who has determined that the user would not like to do business in a particular market (e.g., a particular country or other political jurisdiction) or a particular network (e.g., a portion of the internet) may blacklist the particular market or the particular network. In receipt of this blacklist, an agent may determine not to make a purchase from any merchant in the blacklisted particular market or enlist an agent hosted inside the blacklisted particular market when performing tasks for the user.

As yet another example, a user may set a certain airline as a preferred airline within personal preferences data of the user, and, in receipt of the user's personal preferences data, an agent may give preference to purchasing airfares from the preferred certain airline.

As still another example, a user may establish, within the personal preferences data of the user, that, absent explicit instructions to the contrary, the user never wants to book a rental car when booking travel reservations. Then, in receipt of the user's personal preferences data, when assigned a task of booking travel reservations for the user, an agent may understand that no car rental should be booked, even without having received explicit instructions to this effect from the user.

Sixth agent 230 may determine a seventh agent 240 and transmit a subtask request to seventh agent 240 via connection 242. In parallel or in sequence with this, sixth agent 230 may determine an eighth agent 244 transmit a subtask request to eighth agent 244 via connection 246. Seventh agent 240 may determine that a conventional service may be accessed to perform a subtask in order to complete the subtask assigned to seventh agent 240 from sixth agent 230, such as a data retrieval or processing task, a transaction task, or a payment task, and accordingly, seventh agent 240 may place an API call to third service 248 via link 250, and receive a response from third service 248 via link 252. The response may be a confirmation or an error message, as examples. Seventh agent 240 may transmit a reply, e.g., indicative of the confirmation or error message, to sixth agent 230 via connection 242. As described above with regard to fifth agent 220 and third agent 212, seventh agent 240 may act autonomously in revising and retransmitting an API call to third service 248 via link 250, and/or in replacing third service 248. Seventh agent may also recognize, prior to transmitting a faulty API call to third service 248, one or more defects in the API call, e.g., due to incomplete, incorrect, or ambiguous data that would be provided as part of the API call, and may proactively resolve the fault, e.g., by communicating up the architecture with sixth agent 230, etc., or by conducting other research or intelligent resolution operations, until complete, correct, and/or unambiguous data is received or determined. This proactivity may save time and/or computing and/or network resources by reducing the number of faulty subtask requests or API calls made to downstream services or agents.

Eighth agent 244, which is an AI agent in the illustrated example of FIG. 2, may interact with a human agent system 254 via connection 256 to complete the performance of a subtask assigned to eighth agent 244 by sixth agent 230. Rather than operating autonomously as an AI agent, the human agent system 254 is controlled by a human agent. For example, human agent system 254 may comprise a personal computer or a telephone. As one example, eighth agent 244 may make a phone call or videoconference call to human agent system 254, announce itself as an artificial intelligence, and explain its directives. Eighth agent 244 may, for example, be configured with text-to-speech and speech-to-text capabilities with which to execute this AI-human interaction functionality. As another example, eighth agent 244 may interact with human agent system 254 via a public or private message board or chat room. As yet another example, eighth agent 244 may compose and send email messages to human agent system 254, and receive emails from human agent system 254 in reply. Accordingly, eighth agent 244, an AI, may enlist human aid in accomplishing its assigned subtask. This may happen, for example, in instances in which eighth agent 244 determines that no software service or AI agent is capable of helping it fulfill its subtask, or where eighth agent 244 determines that only a human agent, such as the human agent controlling human agent system 254, is capable of helping eighth agent 244 fulfill its subtask. For example, a human agent controlling human agent system 254 may serve as a gatekeeper to another agentic architecture (not shown) that is a private resource in the control of another party, and that security or privacy concerns, for example, dictate that the private agentic architecture not be accessible by an outside agent, such as eighth agent 244.

Human agent system 254, or another human agent system (not shown), can provide its response via connection 256 or another link (not shown). For example, a task directive could be initially provided to human agent system 254 by telephone, but a follow-up could be transmitted to eighth agent 244 by email, or vice-versa. Upon completion or failure of its subtask, eighth agent 244 can reply to sixth agent 230 via connection 246. Sixth agent 230 can reply to third agent via connection 232. Third agent 212 can reply to first agent 204 via connection 214. First agent 204 can reply to user system 202 via connection 206.

The agentic task architecture 200 of FIG. 2 is but one example, and other agentic architectures, not illustrated, may be simpler or more complex, having fewer or more agents and/or fewer or more data paths. Some example architectures may involve hundreds, thousands, or millions of agents to complete sophisticated tasks. AI agents may be initiated, provisioned, and terminated as needed and/or when called upon by any individual agent, or may persist to assist a plurality of other individual agents. Accordingly, an agentic task architecture may rapidly grow, shrink, reform, and/or be pruned during the course of a task completion.

Additionally, although the illustrated example shows agents replying only to those individual agents that called them after completing (or failing in completing) a subtask, in other examples, agents may reply to multiple other agents, or to agents other than the individual ones that called them, as may be directed by a calling agent. For example, an initial user request may contain an instruction such as, “If you have any questions, direct them to my spouse, and send any confirmations only to my spouse, not to me,” or such a directive could be inferred by some agent within the agentic task architecture. Accordingly, replies within the agentic architecture would be directed in ways in conformance with this directive. As another example, one AI agent responsible for placing a transaction order from another AI agent could command that any receipts for the order be sent only to yet another agent. Accordingly, replies may be routed along agentic network paths that are not merely in the reverse directions of task assignments in an agentic architecture.

### Problems and Advantages Posed by Agentic Task Architectures

A consequence of agentic architectures like that of FIG. 2 is that performance of tasks and transactions may involve a number of AI agents, digital representations, and systems communicating with one another in ways not experienced in conventional task performances and conventional transactions. As one example, whereas a conventional payment transaction may involve a user swiping or tapping of a physical payment card at a point-of-sale (POS) terminal in a brick-and-mortar business location of a merchant, after which the card issuer and the merchant may be the only parties involved in completing the transaction, an agentic task architecture instantiated to complete a transaction may involve multiple parties (e.g., multiple agents, or agents of multiple providers) working with one another to fulfill a transaction request. A user's purchase information and/or payment information may therefore be shared across the multiple parties, with the potential that the processes that place sensitive user information into the hands of these parties may be opaque to the user, e.g., during the course of a task or transaction, which may happen very rapidly. For example, in a complex set of global transactions stemming from a single broad task, tens, hundreds or thousands of parties may be involved over the course of seconds. Accordingly, a user may have no knowledge of, and no ability to meaningfully track in real time, which parties may have obtained the sensitive user data. The parties may be ones with which the user may have had no preexisting relationship or no informed-consented relationship. The various agents involved in a task or transaction may be of various levels of trustworthiness, and/or may be hosted by computing hardware located in various markets (e.g., different countries or other kinds of jurisdictions). Even if initially trusted, some agents may come to be controlled by malicious actors, such as hackers. Some markets (e.g., some countries or other jurisdictions) may have laws or policies that could result in sensitive user information passing through such markets or jurisdictions being turned over to hostile governments or other parties.

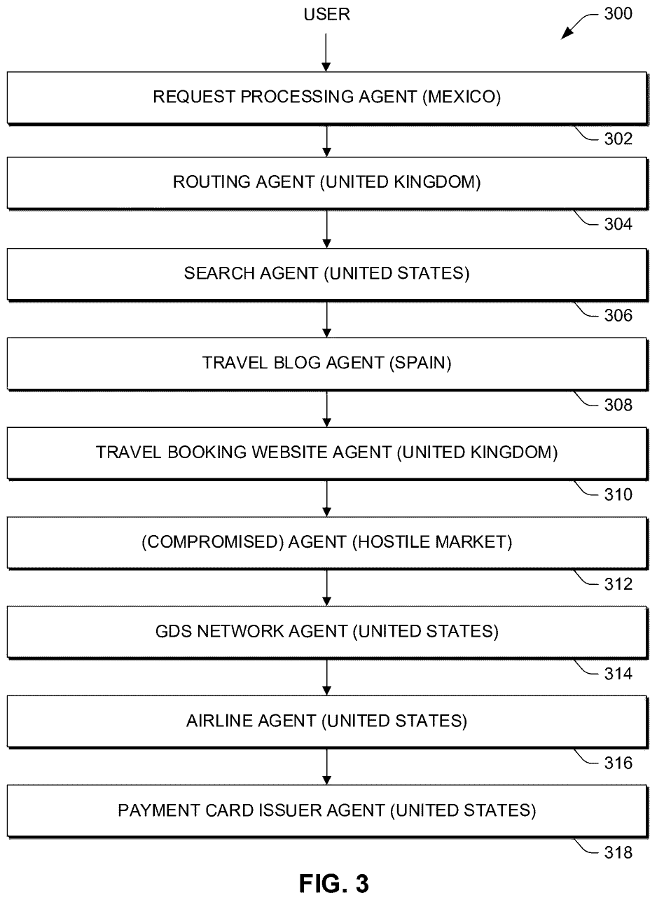

FIG. 3 is a flow diagram 300 of an example information flow through an agentic architecture when a user instructs an agent to book a dream vacation for the user's spouse. In the illustrated example, each agent is an autonomous AI agent. A request processing agent 302, which processes the initial user request to determine the task and perform high-level planning for its execution, is hosted in Mexico. A routing agent 304 that subsequently also receives sensitive user data is hosted in the United Kingdom. The routing agent 304 employs a search agent 306 hosted in the United States. The search agent 306 subsequently employs a travel blog agent 308 hosted in Spain and configured to determine, e.g., from travel blogs published on the internet, what travel destination(s) the vacation should include. The travel blog agent 308 subsequently passes data to a travel booking website agent 310 hosted in the United Kingdom and configured to select and book travel reservations for flights to and from the selected travel destination(s). The travel booking website agent 310 therefore may receive or be authorized to access sensitive user credit data or other payment data in order to carry out one or more travel booking purchase transactions.

The travel booking website then employs an agent 312 that has been compromised by hackers and configured to skim and/or alter sensitive information that passes through it. Additionally or alternatively, agent 312 is hosted in a market that the user considers to be hostile and which may require that all or certain user data that passes through AI agents hosted on servers within its jurisdiction to be passed on to its government. Agent 312 passes the information on to a global distribution system (GDS) network agent 314, which subsequently employs and sends the information on to an airline agent 314, both of which are hosted in the United States. The airline agent 316 may be controlled by the airline and may be representative of the merchant from which airline tickets are ultimately purchased in the illustrated example. The airline agent 316 may interact with a payment card issuer agent 318 hosted in the United States to complete a payment transaction.

In examples in which agent 312 is compromised by hackers, sensitive user data obtained by the compromised agent 312 may be shared with the hackers, who may use the information to commit identity theft or fraud, such as misuse of the user's payment information or credit data. The hackers may also configure the agent to alter the information, so that instead of purchasing a ticket for the user's spouse, the ticket is purchased for another party. Additionally or alternatively, in examples in which agent 312 is hosted in a hostile market, or makes use of a hostile network, the government or governing body of the hostile market or hostile network may receive or seize the sensitive user data, and may misuse it for targeting cyberattacks on the user, for example, or otherwise as part of hostile intelligence-gathering operations. The user may therefore prefer, prospectively, not to permit hostile-market-hosted agents, or agents that make use of hostile networks, be used for the user's tasks, and/or may like to retrospectively receive information that the user's data passed through an agent hosted in a hostile market.

The user's task execution by an agentic architecture may involve, as in the illustrated example, any or all of request processing agent 302, routing agent 304, search agent 306, travel blog agent 308, travel booking website agent 310, agent 312, GDS network agent 314, airline agent 316, payment card issuer agent 318, and entities and/or jurisdictions underlying each of these agents potentially receiving and handling sensitive user data pertaining to the user and/or to the booking transaction. Other, more complex transactions or tasks employing agentic architectures may involve even more parties to complete the steps required of the respective transaction or task, and thus may involve even greater risk of unwanted exposure of sensitive user information. Tracking of agents, and determining which agents are trustworthy, may pose difficult technical challenges.

When properly controlled, however, agentic architectures can offer benefits and advantages over other types of architectures and systems that may lack the cognitive intelligence of AI agents. As one example, a list of user preferences can be provided to an agentic architecture that may preference, de-preference, blacklist, or whitelist certain providers (e.g., certain merchants), certain agents, certain markets, or certain networks, as but a few examples. For example, if a user is a purchaser for a golf course and directs an agent to set up a monthly recurring purchase of golf pencils, but notices that the golf pencils from a certain merchant or a certain market are of consistently low quality, the user can set a preference blacklisting or de-preferencing the certain merchant or the certain market in a preference list. The preference list will be referred to and followed by agents for future purchases, and accordingly, other merchants or merchants from other markets will exclusively or preferentially be used for future purchases of golf pencils, potentially resulting in the purchasing of higher-quality golf pencils. Given the autonomy of agents enlisted to perform tasks, however, enforcing agent adherence to user preference lists may also pose difficult technical challenges.

### Secure, Intelligent Routing for Agentic Task Architectures Using Tokens

System, method, and computer program product embodiments as described herein can improve security, flexibility, and customizability of data routing within complex agentic ecosystems where multiple agents interact to fulfill user requests. By leveraging payload-embedded tokens, e.g., tokens that use the standardized JavaScript Object Notation (JSON) Web Token (JWT) format or a YAML format, an agentic activity monitoring and control system (and/or associated methods or computer program products) can enable efficient and verifiable communication while allowing fine-grained control over routing decisions through configurable authorization rules embedded within each token. The tokens can be embedded within request payloads transmitted from agent to agent within an agentic task architecture, and can thereby be propagated throughout the architecture. The system, method, and computer program product embodiments described herein can also incorporate an incentivized logging mechanism to promote transparency and collaboration among participants while enabling machine-learning-driven analysis of data flows within agentic task architectures to control and improve use of such architectures.

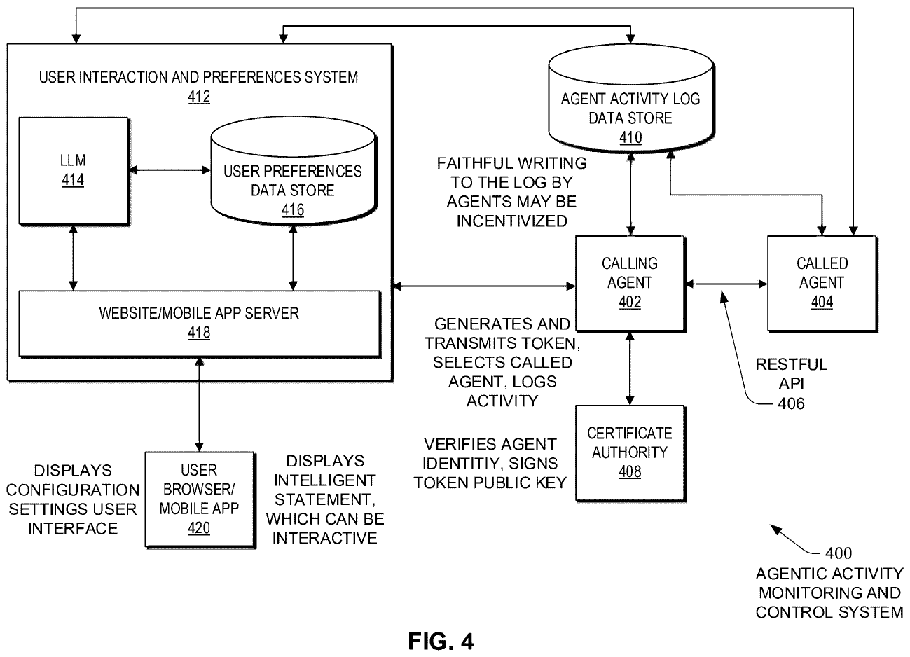

FIG. 4 illustrates an example agentic activity monitoring and control system 400, configured to provide secure, intelligent routing of data within an agentic ecosystem. Secure information exchange between a calling agent 402 and a called agent 404 within an agentic task architecture may take place, for example, using an API that employs representational state transfer (a RESTful API) 406. The RESTful API 406 can, for example, use HTTP requests and responses between agents 402, 404, the requests and responses being sent as REST messages each having a header (or a plurality of headers) and a payload. The RESTful API can accommodate a token, e.g., in an authorization header, that can include authorization credentials containing authentication information of the calling agent 402. The token can further include a hash of the payload that permits verification of authentication and authorization details. The token can further include directives describing who (e.g., which agents) can do what (e.g., can perform what functions with payload data, or can retransmit what payload data). The token can further include other metadata information. The token can further include a signature, which can be, for example, a signature of the payload.

Agentic activity monitoring and control system 400 can further include a user interaction and preferences system 412, which can be, for example, a centralized system that handles receipt of user preferences from user browser or mobile device application 420 and stores user preferences in a user preferences data store 416. The user interaction and preferences system 412 can, for example, be provided (e.g., owned, controlled, and/or hosted) by a payment card issuer. User interaction and preferences system 412 can also include a website or mobile device application server 418 that acts as a server-side backend content generator that can generate user interface content for rendering and display, client-side, by user browser or mobile device application 420. User interaction and preferences system 412 can further include a machine-learning model, such as LLM 414, capable of processing user input from user browser or mobile device application 420 (e.g., natural-language input), reading from and/or writing to user preferences data store 416, and delivering responses to user browser or mobile device application 420 (e.g., as natural language output of user interaction and preferences system 412). User browser or mobile device application 420 may run on any user device, e.g., a personal computer or a mobile device (e.g., smart phone, tablet, or smart watch or other wearable device).

Agents participating in an agentic ecosystem may be unknown and/or untrusted by one another. For example, calling agent 402 may have no history of interacting with called agent 404 prior to discovering called agent 404, e.g., via a web search or search of some other directory of available agents.

In interacting with called agent 404, calling agent 402 may attach a token, e.g., a JWT or YAML token, to its output (e.g., LLM output) as transmitted with a payload in a REST message to called agent 404. The token serves to implement agentic task architecture routing, authorization, and authentication features. The token acts as a digital passport for data. In the context of a larger agentic task architecture of which calling agent 402 and called agent 404 are a part, the token and other tokens used by agents in the architecture function to guide agents through the agentic ecosystem while ensuring secure and authenticated communication between agents. Each token can be cryptographically signed to guarantee its integrity and prevent tampering, establishing a chain of trust among participating agents.

A JWT is a base-64 encoded, JSON-formatted string containing a header section, a body section and a signature section. The body section can contain different declarations referred to in the art as “claims.” These declarations can be used define such information as an issuer of the token, creation and expiration times of the token, preferred, un-preferred, and/or prohibited routes (e.g., agents, networks, markets (e.g., countries), and/or providers (e.g., merchants)) to use in an agentic architecture, and information defining how agents may log data dissemination within the agentic architecture. Given a choice of different routes, an agent will choose to route data through a preferred route, and will choose not to route data through an un-preferred route. Given no choice of different routes (e.g., only one available route), an agent will elect to send data through an available un-preferred route. An agent will not route data through a prohibited route, irrespective of route choice availability.

Listing 1 provides an example token in JWT format.

### LISTING 1: Example Token for Secure, Intelligent Agentic Routing

json
{
“header”: {
“alg”: “RS256”,
“typ”: “JWT”
},
“payload”: {
“iss”: “example_issuer”,
“iat”: 1689696000,
“exp”: 1689782400,
“logger”: {
“url”: “https://logging.example.com/api/log”,
“authMethod”: “Bearer Token”,
“authProvider”: “logging_auth_service_001”
},
“routes”: [
{
“purpose”: “online shopping”,
“structure”: {
“authorizationType”: “OAuth 2.0”,
“authorizationService”: “shop_auth_service_001”,
“preferredProviders”: [
“shop_provider_pubkey_001”,
“shop_provider_pubkey_002”
],
“avoid”: [
“shop_provider_pubkey_003”
]
}
},
{
“purpose”: “customer service”,
“structure”: {
“authorizationType”: “API Key”,
“authorizationService”: “customer_support_auth_001”,
“preferredProviders”: [“support_provider_pubkey_001”
],
“avoid”: []
}
}
]
},
“signature”: “HMACSHA256(base64UrlEncode(header)+‘.’+
base64UrlEncode(payload), provider_private_key)”
}

The header of the example JWT in Listing 1 indicates that the token is a JWT and that the token uses the RS256 signing algorithm, where “RS” indicates that the RSA (Rivest-Shamir-Adleman) public-key cryptosystem is used and the “256” indicates that the 256-bit Secure Hash Algorithm (SHA-256) is used as the signing algorithm.

The payload of the example JWT in Listing 1 contains a number of claims indicating the issuer as example_issuer; the time the JWT was issued (“iat” standing for “issued at”); the expiration time of the JWT; the location, authentication method, and authentication provider of a logger; and routing information. The routing information in the example JWT of Listing 1 contains routing information for use in two contexts: online shopping and customer service. Other example tokens can contain routing information for other and/or additional contexts. In both provided contexts in the example JWT of Listing 1, authorization type and authorization service information is provided. Public keys are also provided to identify preferred, un-preferred, and/or prohibited providers.

In the online shopping context, “shop_provider_pubkey_001” signifies a public key of a first provider (e.g., merchant) listed as a preferred provider, such as a retailer that the user is loyal to, and “shop_provider_pubkey_002” signifies a public key of a second preferred provider (e.g., merchant). On the other hand, the listed public key “shop_provider_pubkey_003” identifies a merchant (or other provider) that the user does not wish to do business with. Agents within an agentic architecture, in receipt of the example token, are thus notified of these preferred, un-preferred, and prohibited providers, and thus may heed instructions to preferentially use them or to avoid using them, as the case may be, within the context of an online shopping task. These instructions thus dictate which agents and services an agent within an agentic task architecture may choose to connect to in furtherance of completion of the online shopping task prompted by the initial user request.

In the customer service context, “support_provider_pubkey_001” signifies a public key of a preferred provider for customer service; no providers are listed as providers to be avoided. Given a choice of different customer service provider agents or services to interact with in an agentic ecosystem, an agent or service indicated by the public key support_provider_pubkey_001 among them, an agent in receipt of the example token will prefer to interact with the agent or service indicated by the public key support_provider_pubkey_001.

Thus, returning attention to FIG. 4, calling agent 402 may generate a token using public key infrastructure (PKI). This may involve, for example, connecting to a certificate authority 408 to verify the identity of the calling agent 402 and thereafter to sign a public key of the calling agent 402, confirming that the public key belongs to the calling agent 402 and that the calling agent 402 is a trustworthy entity. When called agent 404 receives a request from calling agent 402 via RESTful API 406, the request including the generated token, the called agent 404 may verify the token's signature and can consult routing information embedded in the token to determine directives that may guide or restrict the behavior of the called agent 404. The called agent 404 may, for example, decide to forward the request (or a subtask request that is based on the request) to another specialized agent, or may decide to locally process the request (as defined in the payload of the RESTful message) based on authorization rules defined in the token. For example, the authorization rules may dictate preferred, un-preferred, and/or prohibited agents, thus informing choice of the other agent to which the called agent 404 may forward the request or subtask request.

In other examples, not shown in FIG. 4, rather than using a certificate authority, a trust chain or web may be used to assure agent identity. Examples of such trust mechanisms involve all the participants sharing between them the public keys. In still other examples, a reputational ledger can be used to store trustworthiness data relating to different agents in an agentic ecosystem. The reputational ledger can reside on a distributed ledger, such as a blockchain, in which case, instead of public/private key pairs being used to verify agent identity, trusted blockchain addresses can be provided in the token supplied with a request transmitted between agents.

In some examples, the agentic activity monitoring and control system 400 incorporates an agentic activity logging mechanism. The token may specify, for example, a network location of a centralized log, or information indicating how logging may be recorded to a decentralized log, such as a distributed ledger or blockchain. The network location can be indicated, for example, by an HTTP address. The information indicating how logging may be recorded to a decentralized log can include, for example, a trusted blockchain address. In either case, centralized or decentralized, the log and its associated logging mechanism are signified in FIG. 4 by agent activity log data store 410. Participating agents, such as calling agent 402 and called agent 404, may choose to record token usage via the logging mechanism, contributing to a shared understanding of data flow within the agentic task architecture.

Recording of activity to the log by agents may be incentivized to encourage community participation and transparency, providing valuable data for analysis and optimization. In some examples, user interaction and preferences system 412 may grant log read access to any agent, or provider of an agent, that faithfully records its agentic activities to the log. Agents and their providers are thus incentivized to write to the log. The user interaction and preferences system 412 may use trained machine-learning models to search for gaps in the log and thus to identify agents or providers that do not faithfully write to the log, revoking log read access of agents or providers that do not faithfully write to the log. In some examples, user interaction and preferences system 412 may establish a log read/write currency system, by which a number of faithful writes to the log by an agent or provider entitle a proportional number of reads from the log by the agent or provider. In some examples, user interaction and preferences system 412 may preference for selection agents that faithfully write to the log, and/or de-preference agents that do not faithfully write to the log, in effect awarding subtask work to faithful logging agents or providers and/or depriving faithless logging agents or providers of subtask work.

By decentralizing routing decisions and empowering agents with self-contained instructions, agentic activity monitoring and control system 400 eliminates single points of failure in an agentic architecture, enhances scalability of agentic architecture, and fosters a more collaborative agentic ecosystem from which agentic architectures may be built. The secure nature of the tokens described above ensures data integrity throughout the agentic architecture. The incentivized logging mechanism promotes transparency and continuous improvement of the agentic ecosystem through shared insights. Accordingly, agentic activity monitoring and control system 400 enables the development of more intelligent, secure, and adaptable AI agent applications and agentic task architectures capable of handling complex tasks in a trustworthy and collaborative manner.

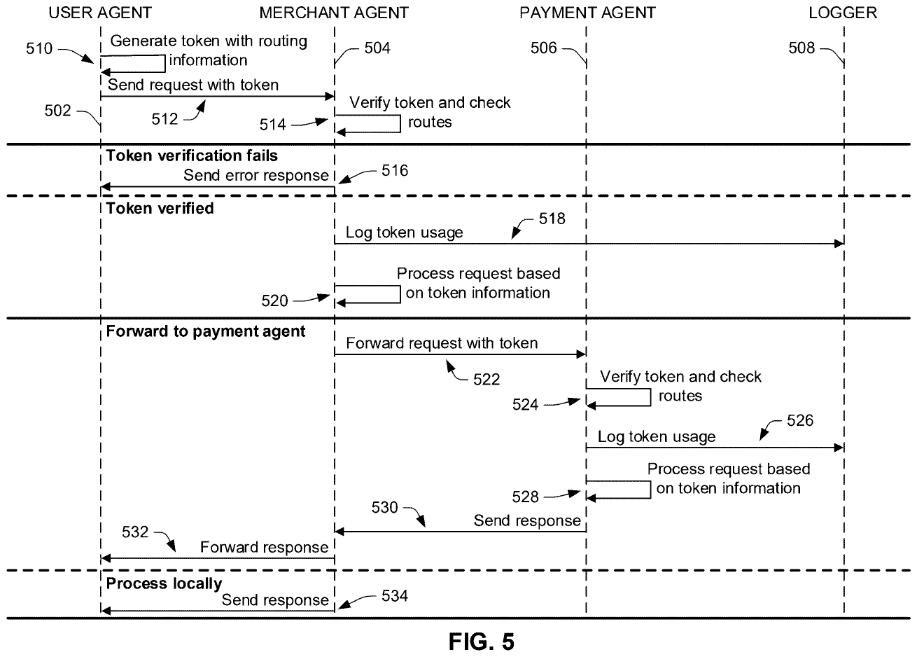

FIG. 5 is a sequence diagram illustrating example interactions between a user agent 502, a merchant agent 504, a payment agent 506, and a logger 508, as may be performed to complete a transaction payment task in accordance with the functioning of agentic activity monitoring and control system 400. Logger 508 can be an AI agent, or may be a simpler system such as a service.

At 510, user agent 502 generates a token (e.g., a JWT) containing routing information. As described above, the routing information can include lists of preferred, un-preferred, and/or prohibited agents, providers (e.g., merchants), markets (e.g., countries), networks, or other parameters. These lists may be organized in different contexts as may be specified in the token. The token can be cryptographically signed.

At 512, the user agent 502 sends a request with the generated token to merchant agent 504. The request with the token may be sent, for example, via an HTTP connection, e.g., over the internet. In some examples, the request and token may be spoken aloud, as when verbally communicating with an AI agent over a telephone connection, for example. The request may include, for example, a payment method and a payment amount agreed to by user agent 502. As examples, the payment amount may have been offered by merchant agent 504 or negotiated between merchant agent 504 and user agent 502 in communications prior to those shown in FIG. 5.

At 514, merchant agent 504 verifies the cryptographic signature of the token. This verification is capable of detecting any tampering with the content of the token, thus preventing an adversary-in-the-middle (AitM) attack from succeeding. After verifying the token's signature, also at 514, merchant agent 504 examines routing information in the token to ensure that one or more agentic routes are available within the agentic ecosystem. For example, if the routing information in the token prohibits use of all options for a necessary subtask agent (e.g., all options for enlisting payment agent 506, in the illustrated example), then it will be impossible for merchant agent 504 to proceed with the payment task, and the task fails. The determination of route availability can include a search of a public or private directory of agents and/or services. If the token verification fails, or if merchant agent 504 determines that no routes are available within the agentic ecosystem, then at 516, merchant agent 504 sends an error response to user agent 502. The error response returned to user agent 502 may indicate that the token was rejected for improper signature, or that no routes were available due to routing rules in the token, whatever the case may be.

If the token is successfully verified and any needed routes are found to be available, then, at 518, merchant agent 504 may log the token usage, e.g., by transmitting information about the token usage to logger 508, which may write the logged token usage to a centralized or distributed log, e.g., agent activity log data store 410 shown in FIG. 4. At 520, the merchant agent 504 processes the request sent to it by user agent 502 based on information provided in the token.

The merchant agent 504 can be equipped with knowledge of different payment agents that it can enlist as payment agent 506, and/or with the ability to determine such knowledge (e.g., by a search of a directory or the internet). For example, merchant agent 504 can have context data useful for choosing an appropriate payment agent from among all valid payment agents. The context data can include a list of payment agents to be used for corresponding payment methods. For example, the context data can indicate that for a Visa or MasterCard payment method, an EMV (Europay, Mastercard, and Visa) processing agent should be selected as payment agent 506, whereas for an American Express card payment method, an AMEX processing agent should be selected as payment agent 506. Merchant agent 504 may make a decision of payment agent according to this context data.

At 522, merchant agent 504 may forward the request to the selected payment agent 506 for processing. In the illustrated example, the forwarded request includes the token originally generated by user agent 502, but in other examples, merchant agent 504 may generate its own token, based on the token received from user agent 502, and the forwarded request may include this token of merchant agent 504. If, however, the token of merchant agent 504 alters the user directives present in the token of user agent 502, this alteration may be apparent in the logs, potentially to the detriment of the reputation for trustworthiness of merchant agent 504 among agents in the agentic ecosystem.

At 524, payment agent 506 verifies the token and checks routes, as described above with regard to token verification and route checking at 514. Not shown in FIG. 5, if the token verification or route checking fails, payment agent 506 can return an error response to merchant agent 504 at this point, as described above with regard to the error response sent from merchant agent 504 to user agent 502 at 516. If the token verification and route checking succeeds, then at 526, payment agent 506 may log the token usage, as described above with regard to logging at 518. At 528, payment agent 506 processes the request based on the token information. For example, payment agent 506 processes the payment amount indicated in the request using a payment network corresponding to the payment method indicated in the request. At 530, payment agent 506 sends a response indicative of the success or failure of the payment processing back to merchant agent 504, which then forwards the response to user agent 502 at 532. User agent 502 may, autonomously and without human input, offer a different payment method in the case of a payment processing failure, effectively repeating the process shown in FIG. 5 with the different payment method indicated in the request sent at 512.

As an alternative to forwarding the request to a payment agent, at 534, merchant agent 504 may, at 520, process the payment request locally. As one example, merchant agent 504 may determine that the payment method is by store private card (a payment card issued by the merchant), not requiring an external payment agent to process. As another example, merchant agent 504 may determine that the payment method is by cryptocurrency, such as a Bitcoin payment. In such cases, merchant agent 504 may be capable of processing the payment locally, and another payment processing agent is not needed. After processing the request locally at 520, at 534, merchant agent 504 sends a response to user agent 502, the response indicating the success or failure of the payment processing. As described above, user agent 502 may autonomously institute a repeating of the process of FIG. 5 with a different payment method in the case of payment processing failure.

In the event of payment processing success, responses sent at 532 or 534 can include, in some examples, a receipt or confirmation of a purchase, or a purchased or licensed digital good (e.g., cryptocurrency, a non-fungible token (NFT), a software application, or a media file or stream). For example, if the purchase is for airline tickets, the response can include an electronic ticket or a ticket booking confirmation, or if the purchase is for an item to be shipped to the user, the confirmation can include a tracking number for the package. Not shown in FIG. 5, in some examples, user agent 510 can be configured to examine the delivery for acceptability and to converse with merchant agent 504 to confirm acceptance or reject the tender and demand unwinding of the transaction.

In some examples, the response sent at 530 can include details about the routing information used by payment agent 506, such as a token used downstream, and the merchant agent 504 may forward this information back to user agent 502 at 532 for tracking purposes.

As noted above with regard to FIG. 2, responsive to an initial user request, an agent in an agentic task architecture may split a request into multiple individual requests to send to other agents downstream, potentially in parallel. For example, if a request to a travel agent is for booking a vacation, a flight booking agent, a hotel accommodations booking agent, and a rental car booking agent may each receive the same token from the travel agent that is upstream of them in the agentic task architecture. Each of these agents may log the token usage, and may extend the token usage downstream by transmitting the token to any other agents enlisted by any of them. The original token can thus be included along with any new tokens generated by subtask agents. The paths taken by tokens, and thus the structures of agentic task architectures, are derivable from logged token usage stored in agent activity log data store 410. For example, an agentic task architecture can be expressed as a Merkle tree. Tokens can be attached and transmitted in various ways, depending on the media or modality that a request is transmitted through (e.g., textually, telephonically, via an image attached to an email or text message, etc.).

### Automatic Generation of Human-readable Agentic Architecture Visualization or Description

With regard again to the agentic activity monitoring and control system 400 of FIG. 4, user interaction and preferences system 412 can use LLM 414, user preferences data store 416, and website/mobile device application server 418 to automatically generate a human-readable agentic architecture visualization or description for a given task or transaction making use of an agentic architecture to satisfy a request of a user. As noted above, user interaction and preferences system 412 can be provided, for example, by a payment card issuer. The agentic architecture visualization or description can be delivered or made available to the user, for example, as part of, or as a supplement to, a regularly issued financial statement. The agentic architecture visualization or description can inform a user (e.g., a cardholder) as to the workflow of the task or transaction, so that a user can be apprised of the steps and flows of data in an agentic task architecture as a task or transaction is attempted. For example, the agentic architecture visualization can show the user what steps took place to consummate a task or transaction, what merchants were involved and their locations, what type of credential was used, and what markets (e.g., countries or other legal jurisdictions) the user's data was passed through in the course of the task or transaction, to trace the task or transaction in a way that shows the user what parties were involved in the task or transaction and actions taken in the course of completing the task or transaction.

Additionally or alternatively, user interaction and preferences system 412 can provide to a user a configuration settings user interface that can offer the user the ability to manage future agentic architecture data flows in accordance with the user's preferences. The configuration settings user interface may provide the user with the ability to, for example, temporarily or permanently preference, de-preference, blacklist, or whitelist certain markets (e.g., certain countries or certain other legal jurisdictions), certain networks, certain providers, certain agents, or certain types of transactions, to allow or prevent certain agents, or all agents operating in certain markets, on certain networks or from certain providers, from being employed in agentic architectures assembled to handle a user's task, or to allow or prevent agents in the performance of certain subtasks or handling of user data in certain ways. Such management features can provide user control over information flows and may thereby enhance the privacy and security of computer networks.

As one example, a user may, via the configuration settings user interface, blacklist certain hostile countries, thereby preventing agents hosted in the blacklisted countries from being employed in an agentic architecture assembled for a task or transaction of the user. As another example, a user may, via the configuration settings user interface, blacklist all car rental bookings, so that when an agent is instructed with the task of booking travel arrangements, the agent will determine subtasks for the task such that a flight and hotel may be booked, but no car rental will be booked. In some examples, the configuration settings user interface can include a preferences user interface page or screen having individual controls for a number of different settings and preferences. In some examples, the configurations settings user interface can include an AI agent with which a user may converse in natural language to set configuration settings.

The aforementioned visualization or description and flow management features may better inform a user and thereby permit a user to better track information flows, better manage the user's privacy, and/or better enforce the user's personal agency throughout an agentic architecture, any of which may be a critical component of fraud detection or prevention, for example.

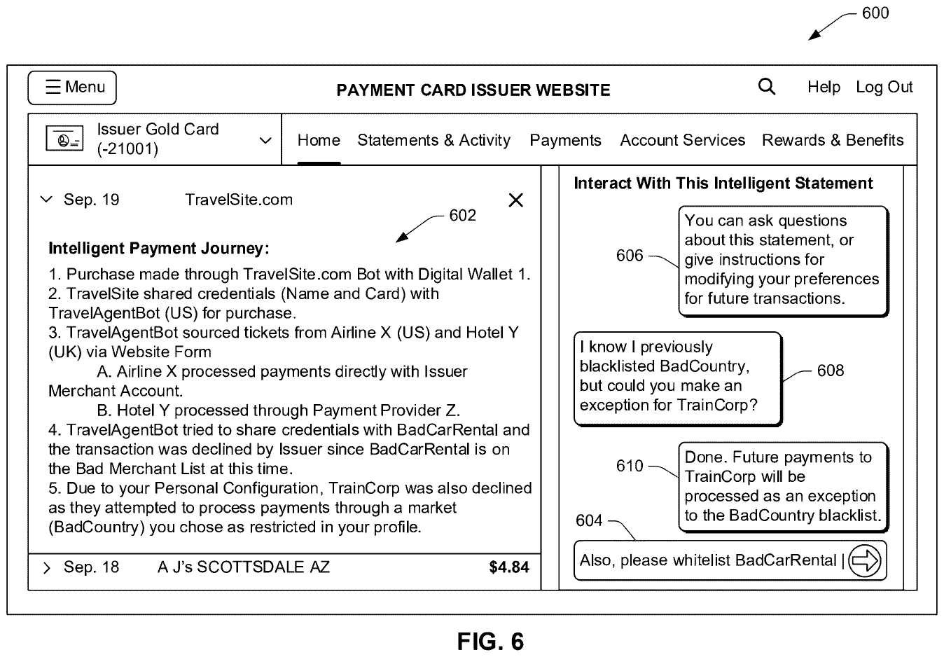

FIG. 6 illustrates a screenshot of an example user interface 600 (e.g., page or screen) of a payment card issuer website or mobile device application, including an intelligent statement 602. The example user interface 600, or one similar to it, can be accessible to a user (e.g., cardholder), for example, by logging into the payment card issuer website using the user's account, which login process may include any number of authentication mechanisms (e.g., password, mobile device challenge, email challenge, text message challenge, biometric challenge, etc.), or by the user opening a mobile device application provided by the payment card issuer on the user's mobile device and authenticating to the mobile device application. For example, the example user interface 600 can be rendered by user browser/mobile device application 420 shown in FIG. 4. The example user interface 600 can provide a listing of recent transactions made using one of one or more payment cards issued by the payment card issuer to the user, with the particular payment card being selectable using a control, in the case that the payment card issuer has issued multiple payment cards to the user. The listing of recent transactions can include, for each transaction made using an agentic task architecture, an intelligent statement 602 that shows or describes a trail of interactions that occurred in furtherance of a given transaction.

In the illustrated example of FIG. 6, intelligent statement 602 is provided as a numbered descriptive narrative, but in other examples, it can be provided as a graph or timeline, e.g., having interactive elements, e.g., elements that when activated by the user (e.g., by clicking or touching) expand to show textual information. The narrative, graph, or timeline of the intelligent statement 602 can be generated, for example, using a generative AI, such as an LLM or other generative system, based on logged data. For example, with regard to FIG. 4, LLM 414 can process data from agent activity log data store 410 to determine agents and routes used in fulfilling a user-requested task, and can generate a written narrative such as the one displayed by intelligent statement 602 in FIG. 6. The generated narrative or other visualization can be incorporated into the payment card issuer website or mobile device application display by website mobile app server 418, and served to a browser or mobile device application 420 displayed on a user device, such as a personal computer, smartphone, or tablet device.

In the illustrated example of FIG. 6, intelligent statement 602 shows that the user booked travel arrangements on September 19 using an AI agent provided by a travel booking site called TravelSite. com, and that the user paid for the travel arrangement booking using a particular digital wallet belonging to the user. The AI agent may have been, for example, a chatbot accessed through the TravelSite. com website. Intelligent statement 602 further shows that TravelSite. com shared the user's data, including the user's name and payment card information, with an AI agent called TravelAgentBot, which was hosted in the United States at the time of the transaction. Intelligent statement 602 further shows that the TravelAgentBot AI agent sourced airline tickets from an airline called Airline X, located in the United States, and hotel accommodations from a hotel called Hotel Y, based in the United Kingdom, using a website form (or respective website forms provided, e.g., by Airline X and Hotel Y). Intelligent statement 602 further shows that Airline X processed payment for the airline tickets directly using its merchant account with the payment card issuer, and that Hotel Y processed payment for the booked hotel accommodates using a third-party payment provider, Payment Provider Z.

Intelligent statement 602 further shows that TravelAgentBot attempted to book a car rental, but failed because payment to the selected car rental merchant, BadCarRental, was declined. Intelligent statement 602 further explains that the reason for the payment to BadCarRental being declined was that BadCarRental was, at the time of the transaction, on merchant blacklist called “Bad Merchant List.” In some examples, the blacklist can have been established by the payment card issuer as a global blacklist that applies to all users serviced by the payment card issuer, with exceptions, in some examples, for users who have whitelisted the otherwise globally blacklisted merchants. In other examples, the blacklist can have been a personal blacklist established by the user, the user having decided, at some point in time before the attempted transaction, that the user would prefer not to do business with the blacklisted merchant, and, accordingly, adding the merchant to the blacklist using the aforementioned configuration settings user interface. The payment card issuer's global blacklist and/or the user's personal blacklist may inform decisions of AI agents in enlisting other AI agents to perform subtasks, and/or may affect payment authorizations decided upon by the payment card issuer or its affiliates. Intelligent statement 602 further shows that TravelAgentBot attempted to book one or more train tickets with a merchant called TrainCorp, but failed because the business TrainCorp is located in a market blacklisted by the user, or an AI agent for TrainCorp is hosted in a market blacklisted by the user.

An intelligent statement, such as intelligent statement 602, can thus serve as a data tracer for the user, that can trace the path of the user's sensitive data, e.g., payment card information, retrospectively alerting the user to the identities of the parties involved in transactions, explaining why certain aspects of a task succeeded or failed, alerting a user to unexpected or opaque steps or verifications that occurred during the completion of a transaction, and explaining the ways in which the operations of the payment card issuer acted to protect the user's sensitive data or the user's finances.

The user interface of the website or mobile device application depicted in FIG. 6 can be interactive to display or hide the details of payment journeys made for individual agentic tasks. In the illustrated example, the payment journey made responsive to a September 19 user request to book a trip is displayed, responsive to a user requesting expanded detail for the September 19 entry, e.g., by activating an expansion control indicated as a twirly arrow. A user seeking more detail on the September 18 transaction listed in the illustrated example could, similarly, expand that entry by activating the corresponding expansion control to the left of the entry listing for that date.

### User Preferences Configuration for Prospective Control of Agentic Operations

In addition to the intelligent statement 602, the screenshot of FIG. 6 further illustrates an interaction chatbot user interface that can be used as a configuration settings user interface and/or as a user interface for intelligent interrogation of the intelligent statement 602. The interaction chatbot user interface includes, in the illustrated example, a text entry field 604. The user can use a text entry input device, such as a physical or virtual keyboard of a user device, to enter text into the text entry field 604. In some examples, the text entry field can accept a dictated user voice input via a microphone of the user device, which can be converted to text entered into the text entry field 604 using a speech-to-text transcription AI model (not shown). The user can thus use text entry field 604 to interact with an interaction chatbot that can be provided, for example, by LLM 414 in FIG. 4. As shown at 606 in FIG. 6, the interaction chatbot can be configured to display an introductory message advising a user of ways in which the user can interact with the interaction chatbot.

As examples, the user can use the text entry field 604 to interact with the chatbot by asking questions or issuing commands in natural language. The questions or commands can be transmitted to the website or mobile app server 418 and processed by the LLM 414 shown in FIG. 4, which can be trained on intelligent statement data and data from the agent activity log data store 410 to understand the underlying meaning of transaction steps taken within an agentic task architecture. The content of the intelligent statement 602 can be provided to the LLM 414 as context data. Accordingly, the LLM 414 can be capable of answering user questions about the content of the intelligent statement 602 and elaborating on the intelligent statement 602. The LLM 414 can also be capable of regenerating or refreshing the intelligent statement 602 based on user input provided by the text entry field 604. For example, if the intelligent statement 602 is unclear as to why a payment failed or why a preferred agent was not used, responsive to a user inquiry, the LLM 414 can revise the intelligent statement 602 to more clearly or elaborately describe the routing decisions executed or processing failures encountered by agents or services in the agentic architecture that was built for the described transaction.

LLM 414 can also access user preferences data store 416 to provide stored user preferences to the user via the interaction chatbot user interface, and/or to modify preferences or record new preferences as indicated in commands issued by the user via the interaction chatbot user interface. The preferences can include routing information included in tokens distributed within an agentic architecture as described above with regard to FIGS. 4 and 5. As examples, such routing information can include preferred, un-preferred, and/or prohibited agents, networks, markets, or providers. As shown at 608 in the illustrated example of FIG. 6, the user uses the text entry field 604 to issue a request to the chatbot to whitelist the provider TrainCorp. As shown at 610, responsive to this request, the user interaction and preferences system 412 creates an exception to a preference rule earlier established by the user to prohibit use of agents operating in the market BadCountry. The user interaction and preferences system 412 can save the exception as a new preference rule or set of preference rules, associated with the user, in the user preferences data store 416.

The created, modified, or updated user preferences for a user in the user preferences data store 416 of user interaction and preferences system 412 can be propagated into, and used to control routing of, agentic architectures when the user makes requests of agents. This can happen in any of several ways. As one example, the user can make an initial request of an agent controlled by the user interaction and preferences system 412, e.g., an agent that that makes use of LLM 414. For example, the user browser/mobile device application 420 can be used to make the initial request to the user interaction and preferences system agent, e.g., via the interaction chatbot user interface or a similar interface. The user interaction and preferences system agent, to which the user's initial request is made, can access the user preferences data store 416 to determine the user's user preferences and generate a token based on the user's user preferences. The token can be, for example, a JWT similar in form to the JWT given in Listing 1, incorporating the user's user preferences in the claims of the JWT payload. The user interaction and preferences system agent can select one or more other agents within an agentic ecosystem in accordance with rules in the user's user preferences when enlisting the one or more other agents to carry out subtasks determined by the user interaction and preferences system agent. The user interaction and preferences system agent can transmit the token along with requests that the user interaction and preferences system agent makes to other agents within the agentic ecosystem, and the other agents can read the content of the token and adhere to rules set forth in the token when selecting other agents within the agentic ecosystem to carry out other subtasks.

As another example, the user can make the initial request to an agent that, though not controlled by the user interaction and preferences system 412, nevertheless is trained or otherwise configured to access the user preferences data store 416 to retrieve the user's preferences before calling another agent within the agentic ecosystem to perform a subtask. The agent can generate a token, as described above, using the retrieved user preferences, and thereby may control and log agentic operations during the course of task performance as the token is consulted when building an agentic task architecture and passed from agent to agent within the agentic task architecture.

As another example, a user device may store a local copy of the user's preferences, as may be stored in the user preferences data store 416, and the user device may transmit all or a relevant portion of the local copy of the user's preferences to an agent called to perform a task for the user. In this case, the called agent, though not controlled by the user interaction and preferences system 412, nevertheless may receive the user preferences or portion thereof, from which the agent generate a token, as described above, using the received user preferences, and thereby may control and log agentic operations during the course of task performance as the token is consulted when building an agentic task architecture and passed from agent to agent within the agentic task architecture.

Agentic activity monitoring and control system 400 thus establishes a feedback loop that can be used for agentic activity control. Called agents receive user preference data that ultimately comes from the user preferences data store 416 (or a local copy thereof), use the user preference data to make routing decisions, and log such decisions and other activity to the agent activity log data store 410. Log data in the agent activity log data store 410 may subsequently be used to inform changes or refinements to the user preferences that can further adjust agentic activity. The feedback loop can be a human-in-the-loop control loop, with a human user making the user preferences changes, e.g., after viewing an intelligent statement, such as intelligent statement 602, or the control loop can be a completely automated control loop, with a machine learning model making the user preferences changes based on the log data.

In some examples of agentic activity monitoring and control system 400, not shown, the agent activity log data store 410 can be included in the user interaction and preferences system 412, e.g., hosted on one or more servers owned or controlled by the payment card issuer.

### Methods of Agentic Routing Monitoring and Control

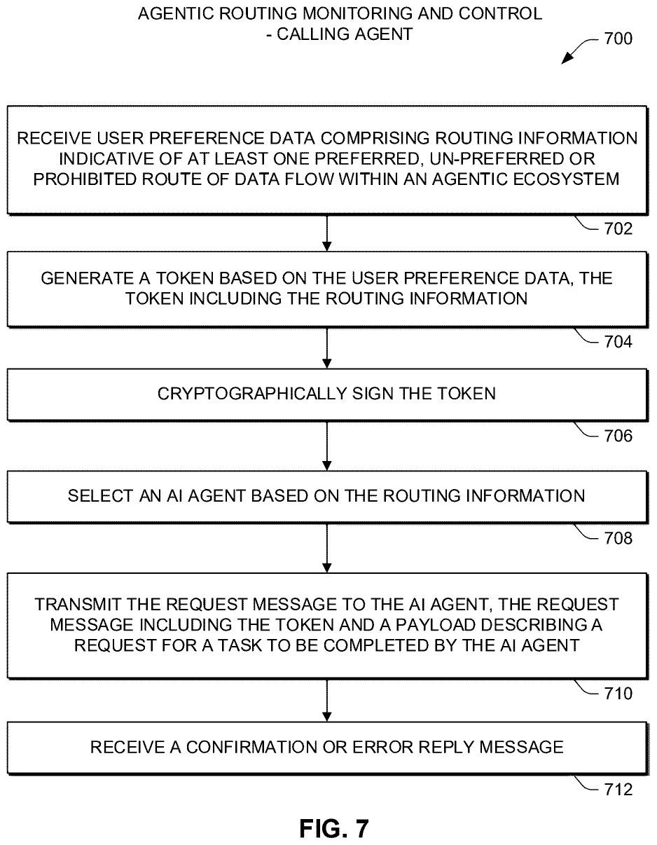

The flow diagram of FIG. 7 illustrates an example computer-implemented method 700 of agentic routing monitoring and control, e.g., of routing within an agentic task architecture. At 702, user preference data comprising routing information is received, e.g., by an AI agent, e.g., by a computer processor executing software code to run the AI agent. The AI agent can be, for example, calling agent 402 in FIG. 4. The routing information is indicative of at least one preferred, un-preferred, or prohibited route of data flow within an agentic ecosystem. For example, the user preference data can have been set by the same or a different AI agent, e.g., that uses an LLM, based on input provided via a user interface, such as a chatbot. As examples, the routing information can include at least one preferred, un-preferred, or prohibited agent, market, provider, or network.

At 704 the AI agent or computer processor generates a token based on the user preference data, the token including the routing information. For example, the AI agent or computer processor can generate the token as a JWT that includes the routing information in the claims of the payload of the JWT.

At 706, the AI agent or computer processor cryptographically signs the token. For example, the AI agent or computer processor can enlist a certificate authority, such as certificate authority 408 in FIG. 4, to verify the AI agent identity and sign a public key of the token.

At 708, the AI agent or computer processor can select an AI agent of the agentic ecosystem based on the routing information. For example, the AI agent or computer processor can search the internet or consult a directory for AI agents capable of performing a task (e.g., subtask) that the AI agent or computer processor wishes to have performed, and can select from the results of the search or directory consultation an AI agent that complies with directives in the routing information as the selected AI agent of the agentic ecosystem. For example, the selected AI agent of the agentic ecosystem can be called agent 404 of FIG. 4.

At 710, the AI agent or computer processor can transmit a request message to the selected AI agent of the agentic ecosystem, the request message including the token and a payload describing a request for the task to be completed by the selected AI agent of the agentic ecosystem. The recipient agent (the selected AI agent, e.g., called agent 404 of FIG. 4) can receive the token (e.g., JWT) as part of the text payload (e.g., embedded in the payload) even if the recipient agent is exposed as an API (e.g., a RESTful API). The recipient agent can extract the token, verify it, and, at its discretion, may forward the request to a subsequent agent, as specified in the token.

At 712, the AI agent or computer processor can receive, from the selected AI agent of the agentic ecosystem, a reply message containing a confirmation that the selected AI agent successfully completed the task or an error message describing a reason why the selected AI agent did not successfully complete the task.

Not shown in FIG. 7, the method 700 can further include the AI agent or computer processor transmitting a logging message to a log. As one example, the AI agent or computer processor can send the logging message to an HTTP address of a logger service or a logger AI agent, the HTTP address being included in the token. As another example, the logging message is sent to a blockchain address for a distributed log, the blockchain address being included in the token.

When performed by different AI agents within an agentic ecosystem (or corresponding computer processors), method 700 results in routing monitoring and control to build an agentic task architecture that can accomplish any one or more of various objectives of the routing information, such as making the task completion more efficient and thereby saving on processing resources (e.g., processor cycles or memory consumption) or reducing network congestion, or making the task completion more secure by not routing sensitive user information through agents, networks, markets, or providers considered by the user or by another system to be insecure.

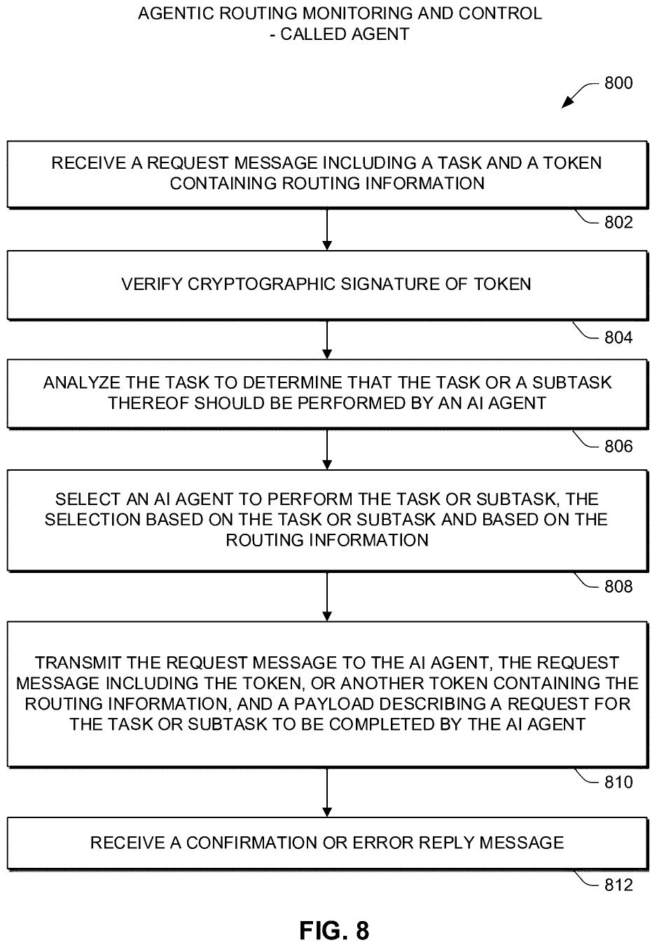

The flow diagram of FIG. 8 illustrates an example computer-implemented method 800 of agentic routing monitoring and control, e.g., of routing within an agentic task architecture. At 802, a request message is received, e.g., by an AI agent, e.g., by a computer processor executing software code to run the AI agent. The AI agent can be, for example, called agent 404 in FIG. 4. The request message can include a task and a token including routing information. The token can be, e.g., a JWT that includes the routing information in the claims of the payload of the JWT, as described above. The routing information is indicative of at least one preferred, un-preferred, or prohibited route of data flow within an agentic ecosystem. For example, the routing information can have been based on user preference data can have been set by the same or a different AI agent, e.g., that uses an LLM, based on input provided via a user interface, such as a chatbot. As examples, the routing information can include at least one preferred, un-preferred, or prohibited agent, market, provider, or network.

At 804, the AI agent or computer processor can verify a cryptographic signature of the token. For example, the AI agent or computer processor can compare a hash of the token with a hash derived from decrypting a signature of the token using a public key of a sender of the request message. If the hashes match, the cryptographic signature can be considered verified, meaning that that token can be trusted as not having been maliciously modified. In some examples, the public key of the token can have been signed by a certificate authority, such as certificate authority 408 in FIG. 4.

At 806, the AI agent or computer processor can analyze the task to determine that the task or a subtask thereof should be performed another AI agent. For example, the AI agent or computer processor can use an LLM or other machine-learning model to analyze the task. The AI agent or computer processor may determine, for example, that the task can be completed by breaking it up into a number of subtasks, one or more of which can be assigned to the other AI agent. As one example, the AI agent or computer processor may recognize that the other AI agent is specialized to be capable of performing the task or subtask, whereas the AI agent or computer processor is not capable of performing the task or subtask. As another example, the AI agent or computer processor may recognize that the other AI agent is has access to a resource, such as a data store or a payment network, required for performing the task or subtask, whereas the AI agent or computer processor does not have access to the required resource. As yet another example, the AI agent or computer processor may recognize that the other AI agent is capable of performing the task or subtask more efficiently, more quickly, or at lower cost than the AI agent or computer processor.

At 808, the AI agent or computer processor can select, as the other AI agent, an AI agent of the agentic ecosystem based on the routing information. For example, the AI agent or computer processor can search the internet or consult a directory for AI agents capable of performing the task or subtask, and can select from the results of the search or directory consultation an AI agent that complies with directives in the routing information as the selected AI agent of the agentic ecosystem.

At 810, the AI agent or computer processor can transmit a request message to the selected AI agent of the agentic ecosystem, the request message including the token, or another token containing the routing information, and a payload describing a request for the task or subtask to be completed by the selected AI agent of the agentic ecosystem.

At 812, the AI agent or computer processor can receive, from the selected AI agent of the agentic ecosystem, a reply message containing a confirmation that the selected AI agent successfully completed the task or an error message describing a reason why the selected AI agent did not successfully complete the task.

Not shown in FIG. 8, the method 800 can further include the AI agent or computer processor transmitting a logging message to a log. As one example, the AI agent or computer processor can send the logging message to an HTTP address of a logger service or a logger AI agent, the HTTP address being included in the token. As another example, the logging message is sent to a blockchain address for a distributed log, the blockchain address being included in the token.

When performed by different AI agents within an agentic ecosystem (or corresponding computer processors), method 800 results in routing monitoring and control to build an agentic task architecture that can accomplish any one or more of various objectives of the routing information, such as making the task completion more efficient and thereby saving on processing resources (e.g., processor cycles or memory consumption) or reducing network congestion, or making the task completion more secure by not routing sensitive user information through agents, networks, markets, or providers considered by the user or by another system to be insecure.

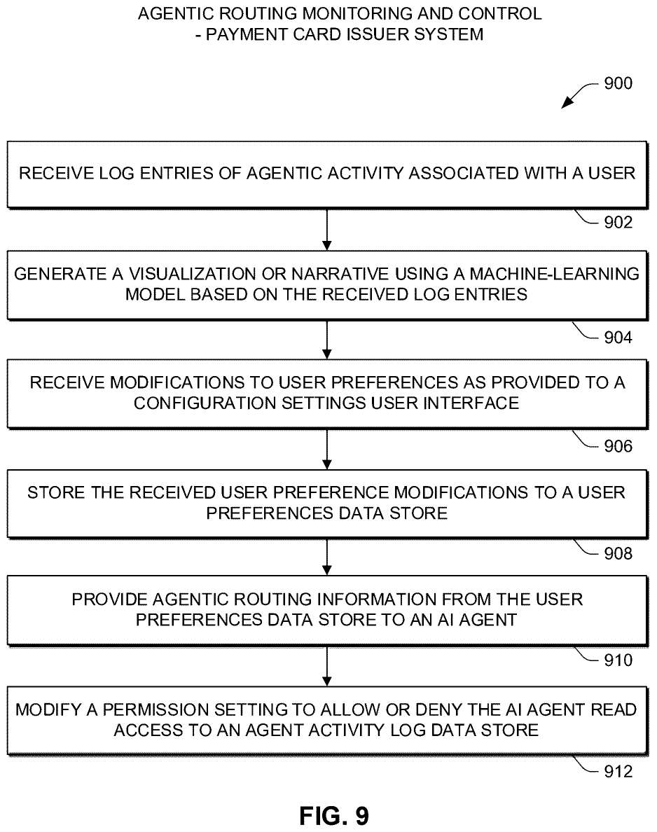

The flow diagram of FIG. 9 illustrates an example computer-implemented method 900 of agentic routing monitoring and control, e.g., of routing within an agentic task architecture. At 902, an AI agent or computer processor can receive log entries of agentic activity associated with a user 902. For example, the log entries can be representative of the activity of a plurality of agents in an agentic task architecture. For example, the log entries can have been created by agents as described above with regard to FIG. 5. The log entries can be received, for example, from an agentic activity log data store, such as agentic activity log data store 410 in FIG. 4. The AI agent or computer processor can, for example, be part of a user interaction and preferences system, such as user interaction and preferences system 412 in FIG. 4.

At 904, the AI agent or computer processor can generate a visualization or narrative using a machine-learning model based on the received log entries. The machine-learning model can be, for example, an LLM, such as LLM 414 in FIG. 4, or another generative AI trained to generate visualizations or narratives based on agentic activity log data. The generated visualization or narrative can be rendered to a user interface, e.g., as an intelligent statement, such as intelligent statement 602 shown in FIG. 6.

At 906, the AI agent or computer processor can receive modifications to user preferences as provided to a configuration settings user interface. The modifications to the user preferences can include, for example, at least one preferred, un-preferred, or prohibited agent, provider, market, or network. The configuration settings user interface can include, for example, an interaction chatbot user interface, such as the interaction chatbot user interface shown in FIG. 6. The modifications to the user preferences can be, for example, responsive to the generated visualization or narrative, as shown in the example of FIG. 6.

At 908, the AI agent or computer processor can store the received user preference modifications to a user preferences data store, such as user preferences data store 416 shown in FIG. 4.

At 910, the AI agent or computer processor can provide agentic routing information from the user preferences data store to another AI agent. For example, the agentic routing information can include the at least one preferred, un-preferred, or prohibited agent, provider, market, or network. The other AI agent can be, for example, an AI agent enlisted to perform a task for the user with whom the agentic activity log entries were received at 902. The other AI agent can, for example, be one trained or otherwise configured to write logs of agentic activity to an agentic activity log data store, such as agentic activity log data store 410 in FIG. 4.

At 912, the AI agent or computer processor can modify a permission setting to allow or deny the other AI agent read access to an agent activity log data store. For example, the agent activity log data store can be one from which the log entries were received at 902 and/or to which the other AI agent is trained or otherwise configured to write logs of agentic activity. For example, the AI agent or computer processor can modify the permission setting based on determining whether or not the other AI agent has faithfully written its agentic activity to the agent activity log data store. For example, the AI agent or computer processor can analyze log entries in the agent activity log data store to determine that gaps in the agent activity log are indicative of failures of the other AI agent to log its agentic activity to the agent activity log data store. For example, the AI agent or computer processor can use a machine learning model trained to analyze the agent activity log to find logging gaps and determine one or more AI agents responsible for the logging gaps.

When performed in the context of an agentic ecosystem (or corresponding computer processors), method 900 can enforce proper routing of sensitive user information within the agentic ecosystem, resulting in routing monitoring and control to build an agentic task architecture that can accomplish any one or more of various objectives of the routing information, such as making the task completion more efficient and thereby saving on processing resources (e.g., processor cycles or memory consumption) or reducing network congestion, or making the task completion more secure by not routing sensitive user information through agents, networks, markets, or providers considered by the user or by another system to be insecure.

### Computing Systems Useful in Agentic Routing Monitoring and Control

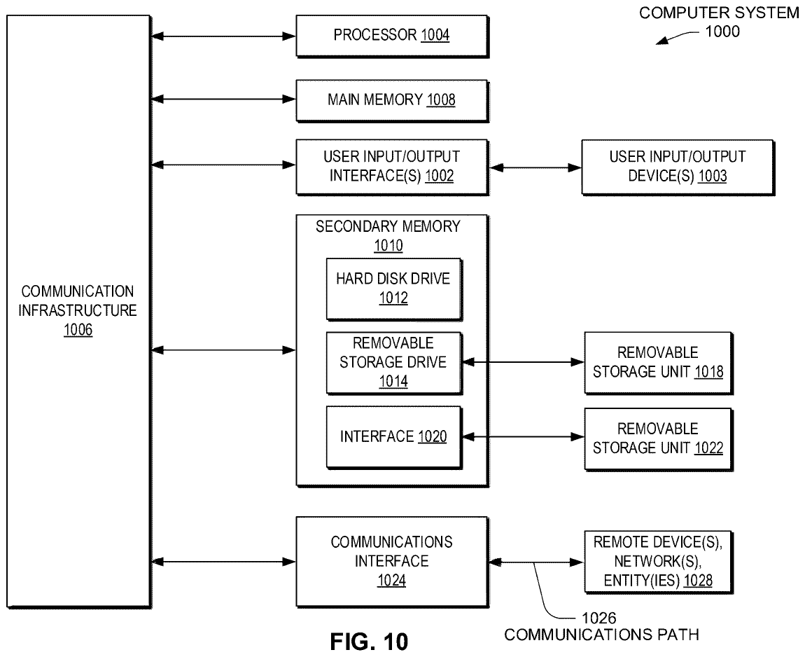

Various embodiments may be implemented, for example, using one or more classical computer systems, such as computer system 1000 shown in FIG. 10. One or more computer systems 1000 may be used, for example, to implement aspects of embodiments discussed herein, as well as combinations and sub-combinations thereof. One or more computer systems 1000 may be used, for example, to implement aspects of agents or services of FIG. 2 or 5, the user interaction and preferences system 412 of FIG. 4, the calling agent 402 or called agent 404 of FIG. 4, the agent activity log data store 410 of FIG. 4, the user browser/mobile device application 420 of FIG. 4, the certificate authority 408 of FIG. 4, or the agentic routing monitoring and control methods 700, 800, or 900 of FIGS. 7, 8, or 9. These and other aspects may also be implemented with one or more known quantum computing systems (not shown).

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a graphics processing unit (GPU), a tensor processing unit (TPU), or an AI processing unit (AIPU). In an embodiment, a GPU, TPU, or AIPU may be a processor that is a specialized electronic circuit designed to process mathematically intensive applications. The GPU, TPU, or AIPU may have a parallel structure that is efficient for parallel processing of large blocks of data, such as mathematically intensive data common to computer graphics or ML applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the internet of things (IoT), and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premises” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

### Conclusion

Token-based routing of user information within networks of AI agents, as described herein, can enable secure, efficient, and collaborative communication within complex agentic ecosystems. By embedding detailed routing information and authorization rules directly into tokens, such as JWTs, the need for centralized routing services that dictate routes can be eliminated and agents can be empowered to make autonomous decisions based on predefined policies set forth in the tokens. Token-based routing not only can enhance agentic system performance and scalability, but can also strengthen security by minimizing potential points of failure and attack vectors. Furthermore, an incentivized agentic activity logging mechanism fosters a transparent and trustworthy environment where participating agents actively contribute to a comprehensive understanding of data flow within an agentic network.

The Detailed Description section, and not any other section, is intended to be used to interpret the claims. Other sections can set forth one or more but not all example embodiments as contemplated by the inventors, and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method of routing within an agentic task architecture, the method comprising:
receiving, by a computer processor, user preference data comprising routing information indicative of at least one preferred, un-preferred, or prohibited route of data flow within an agentic ecosystem;
generating a token based on the user preference data, the token including the routing information;
cryptographically signing the token;
selecting an artificial intelligence (AI) agent of the agentic ecosystem based on the routing information;
transmitting a request message to the AI agent, the request message including the token and a payload describing a request for a task to be completed by the AI agent; and
receiving, from the AI agent, a reply message containing a confirmation that the AI agent successfully completed the task or an error message describing a reason why the AI agent did not successfully complete the task.

2. The method of claim 1, further comprising transmitting, by the computer processor, to a log, a logging message.

3. The method of claim 2, wherein the logging message is transmitted to a Hypertext Transfer Protocol (HTTP) address of a logger service or a logger AI agent, and wherein the token further includes the address.

4. The method of claim 2, wherein the logging message is transmitted to a blockchain address for a distributed log, and wherein the token further includes the blockchain address for the distributed log.

5. The method of claim 1, wherein the routing information includes at least one agent, market, provider, or network indicated as preferred, un-preferred, or prohibited in the user preference data.

6. The method of claim 1, wherein the AI agent is a first AI agent, and the preference data is set by a second AI agent based on input provided via a user interface.

7. The method of claim 6, wherein the user interface is a chatbot.

8. An agentic task architecture routing system comprising:
a memory; and
at least one processor coupled to the memory and configured to perform operations comprising:
receiving user preference data comprising routing information indicative of at least one preferred, un-preferred, or prohibited route of data flow within an agentic ecosystem;
generating a token based on the user preference data, the token including the routing information;
cryptographically signing the token;
selecting an artificial intelligence (AI) agent of the agentic ecosystem based on the routing information;
transmitting a request message to the AI agent, the request message including the token and a payload describing a request for a task to be completed by the AI agent; and
receiving, from the AI agent, a reply message containing a confirmation that the AI agent successfully completed the task or an error message describing a reason why the AI agent did not successfully complete the task.

9. The agentic task architecture routing system of claim 8, wherein the operations further comprise transmitting a logging message to a log.

10. The agentic task architecture routing system of claim 9, wherein the logging message is transmitted to a Hypertext Transfer Protocol (HTTP) address of a logger service or a logger AI agent, and wherein the token further includes the address.

11. The agentic task architecture routing system of claim 9, wherein the logging message is transmitted to a blockchain address for a distributed log, and wherein the token further includes the blockchain address for the distributed log.

12. The agentic task architecture routing system of claim 8, wherein the routing information includes at least one agent, market, provider, or network indicated as preferred, un-preferred, or prohibited in the user preference data.

13. The agentic task architecture routing system of claim 8, wherein the AI agent is a first AI agent, and the preference data is set by a second AI agent based on input provided via a user interface.

14. The agentic task architecture routing system of claim 13, wherein the user interface is a chatbot.

15. A non-transitory computer-readable device having instructions stored thereon that, when executed by at least one computing device, cause the at least one computing device to perform operations comprising:
receiving user preference data comprising routing information indicative of at least one preferred, un-preferred, or prohibited route of data flow within an agentic ecosystem;
generating a token based on the user preference data, the token including the routing information;
cryptographically signing the token;
selecting an artificial intelligence (AI) agent of the agentic ecosystem based on the routing information;
transmitting a request message to the AI agent, the request message including the token and a payload describing a request for a task to be completed by the AI agent; and
receiving, from the AI agent, a reply message containing a confirmation that the AI agent successfully completed the task or an error message describing a reason why the AI agent did not successfully complete the task.

16. The non-transitory computer-readable device of claim 15, wherein the operations further comprise transmitting a logging message to a log.

17. The non-transitory computer-readable device of claim 16, wherein the logging message is transmitted to a Hypertext Transfer Protocol (HTTP) address of a logger service or a logger AI agent, and wherein the token further includes the address

18. The non-transitory computer-readable device of claim 16, wherein the logging message is transmitted to a blockchain address for a distributed log, and wherein the token further includes the blockchain address for the distributed log.

19. The non-transitory computer-readable device of claim 15, wherein the routing information includes at least one agent, market, provider, or network indicated as preferred, un-preferred, or prohibited in the user preference data.

20. The non-transitory computer-readable device of claim 15, wherein the AI agent is a first AI agent, and the preference data is set by a second AI agent based on input provided via a user interface.
